(19) United States
(12) Patent Application Publication
(10) Pub. No.: US 2026/0260278 A1
(43) Pub. Date: Sep. 3, 2026

(54) METHOD AND SYSTEM FOR PERSONAL AI AGENT FOR AUTOMATED INFORMATION CURATION AND PRODUCT CUSTOMIZATION AND IMPLEMENTATION

(71) Applicant: PARTICLE MEDIA, INC., Mountain View, CA (US)

(72) Inventors: Zhaohui Zheng, Palo Alto, CA (US); Juntong Song, Mountain View, CA (US); Xu Ji, Bellevue, WA (US); Xiaoxi Wu, Palo Alto, CA (US); Rongqing Lu, Palo Alto, CA (US)

(21) Appl. No.: 19/552,451

(22) Filed: Feb. 27, 2026

Related U.S. Application Data
(60) Provisional application No. 63/788,720, filed on Apr. 14, 2025.
(60) Provisional application No. 63/764,927, filed on Feb. 28, 2025.

(51) Int. Cl. G06Q 30/0601

(52) U.S. Cl. CPC G06Q 30/0631; G06Q 30/0621

(57) ABSTRACT

System and method for an artificial intelligence assisted product agent (AAPA) and applications thereof. Via communication with a user in a natural language regarding a product providing a service to a user on a device of the user, the AAPA updates the interests/preferences of the user, including a preference regarding a service feature of the product. Based on product knowledge specified to facilitate automated interaction with the product, the AAPA interfaces with the product to automatically yield a customized product that delivers the service using the service feature implemented according to the user’s preference.

### CROSS REFERNCE TO RELATED APPLICATIONS

The present application claims the benefit and priority of U.S. Provisional Patent Application No. 63/764,927, filed on Feb. 28, 2025, and U.S. Provisional Patent Application No. 63/788,720, filed on Apr. 14, 2025, the contents of which are hereby incorporated by reference in their entireties.

### BACKGROUND

### 1. Technical Field

The present teaching generally relates to computers. More specifically, the present teaching relates to artificial intelligence (AI) agents and applications thereof.

### 2. Technical Background

In the last several decades, more and more human activities have migrated to online. People get news/information from online, buy goods from online, communicate with friends/colleague online, and even conduct transactions online. This is depicted in FIG. 1A, where a user 110 interacts, via a network 120, with various content providers/portals/curators/ recommenders 130 to obtain/submit content to the Internet as well as with different products/service providers/advertisers/distributors/recommenders 140 to receive/offer products/services and make transactions. The network 120 includes the traditional network connections such as public switched telephone network (PSTN), wireless networks, the Internet, a local area network (LAN), a wide area network (WAN), a virtual network, or any combination thereof. A content provider in 130 may include both traditional ones (e.g., newspapers and radios providing content via traditional communication platforms) and those operating in new or emerging platforms (e.g., via online search or push for content offering or recommendations). Similarly, a service provider for products/services in 140 may also include both traditional ones delivering services via traditional means (e.g., phone calls) and emerging ones that deliver services via online clicks across the Internet.

In the online world, people nowadays consume information mostly from the Internet and online content may be made available to users via pull (links to content via searching using queries/prompts) or push (content links sent to users via recommendation/ subscription). To access content available (via pulling or pushing), a user may simply click on accessible content items. In a pull scenario, a user may formulate a query/prompt (hereinafter “query”) representing some interested subject matter and submit the query to a search engine, a portal, or an artificial intelligence (AI) chat agent for searching online content relating to the subject matter. That is, whenever a user needs content vi a pull mechanism, the user needs to formulate a query, even when the query is identical to a previously submitted query to receive the content in the desired subject matter. In a push scenario, a content provider may unilaterally, without users’ requesting, recommend certain content to a user. In some situations, the recommendations may be made based on interests of individual users, either declared by the users or estimated for each user based on indirect data, such as the observed activities of the user on different pieces of content. In some situations, content recommendations may also be made using other criteria, e.g., content with trending topics, etc. The recommended content pushed to users may not meet the users’ desire at the recommendation time because the declared interests may change over time and/or the estimated interests using indirect data may not be reliable.

In addition to content related services, another aspect of daily life that has shifted substantially online is on commerce. People nowadays conduct online transactions relating to products/services via electronic means. Such online transactions broadly include varieties of products/services covering most daily needs and may be carried out via websites, online applications, dedicated e-commerce platforms, or even social media sites such as Facebook, TikTok, etc. For instance, online clock application replaced almost all physical clock products and online GPS has long made physical maps almost non-existent. While there are many products/services made available online, they still exist in parallel marketplaces, i.e., the physical marketplace and the online marketplace. For instance, the traditional weather reporting program exists in traditional media while millions use online weather reporting apps for the same purpose. The same can be said about clocks, alarms, sales of products, lectures, etc. In addition, because of the co-existing marketplaces, more and more products/services are put in the respective marketplaces to improve accessibility of products/ services on alternative marketplaces. Although intended for easy access and convenience to customers, such enriched ways to obtain products/services also caused much confusion to users, not only as to which product/service from which market is appropriate for what purposes.

In general, each of product/service providers, especially online ones, nowadays provides a means to communicate with its users via an interface to, e.g., present the product/service information, receive information from a user, such as selection of a product/service, obtain payment information, shipping address, comments/feedback, etc. For example, online content recommendation applications may display, to an online user, information selected based on estimated user interests. Online commerce platforms such as Amazon, eBay, Etsy, Chairish, etc. may operate their respective online business by presenting product/service related information to allow customers to review, to order, to ask questions, to provide feedback. Each such business has its own designed interface with, e.g., designed font size, font style, layout of each page, specific way to change the setting, etc. This may cause further confusion to users because of the need to learn and adapt to each in terms of how to operate the interface or change to a setting of each user’s liking to properly use the product/service. For example, the default interface setting of an online product may use a certain font size which may not be desirable to some users (e.g., the font size may be too small for users who have trouble to see small font sizes). To modify the default setting, a user has to figure out where and how to change the original setting.

With the advancement of the Internet, millions of applications have been developed and deployed on millions of personal devices around the world to conduct different activities, from getting daily news (local, national, and international), reviewing information on commercial products, making purchases, selling products, scheduling desired services, and providing feedback on online content/products/services. Given the volume of what is available, both offline and online, it can be quite overwhelming to users (such as user 110 in FIG. 1A) as to how to find what is needed, what to select when multiple products/services for the same need are available, and how to configure each such product in a way that is suitable to each user. This is illustrated in FIG. 1B, where the user 110 can connect to literally millions of products/services via network 120, including different online applications that may be downloaded onto personal devices, websites hosted by product/service providers, online shopping platforms (e.g., Amazon, eBay, etc.), information services such as search engine, content portal, social media, interest groups, etc., and various products/services that may be just a phone call away, including taxi services, rental car services, airline services, hotels, restaurants, various shops that can take orders over a call or via websites.

As discussed herein, while it is beneficial to make many products/services available to consumers to enable services via online clicks or simple phone calls, it has also gradually become a source of confusion or even frustrations to users due to the volume of information and lack of a mechanism to allow users to effectively make decisions on when to use which product to serve which needs, let alone to make a selected product configured in a satisfactory manner to serve the needs. Although some efforts have been made in the marketplace to make it easier for users by, e.g., providing products such as Yelp to categorize available products with rankings to allow users to develop some sense of which products will serve their needs. However, such products can only provide generic evaluations of products without being able to assist users to understand the nuance of such products/services. In addition, as each of the products/services as shown in FIG. 1B has its own ways of interfacing with a user in, e.g., signing up with required security or authentication information, it is simply becoming very difficult, if not impossible, to maneuver effectively to explore, select, and use suitable products/services.

It is like the scenario associated with earlier electronic devices, such as VCR. When such devices became sophisticated with more and more functions, the percent of users who actually leveraged such advanced functions was often low due to lack of support to assist users to explore what were available. Today’s marketplace is worse because millions of apps/products/services are available and each requires users to understand its unique way to operate, even on the same service. A user with a limited time each day may feel overwhelmed and frustrated, as shown in FIG. 1C. For example, a search for a product online may yield a long list of alternatives. Some users may prefer a product with larger font size to make it easier to operate. Other users may prefer to have different interface features. Currently, there is no such guidance to enable a user to select or to operate. Some products may offer fixed features and fixed way to operate. Some may provide some configurable features, e.g., interface characteristics such as font style and font size. Yet, to change a default configuration, a user is required to learn how to maneuver in the product to get that done. It is nowadays common that people spend more time to browse different product offerings, try different alternatives, learn how to operate different products, spend time to reset the product to operate in a satisfactory manner, to upgrade the product, and to get familiar with the changes in the upgraded version, etc. Thus, despite that the explosive availability of online and offline products/services are intended to provide convenience to users, without effective means to guide users to make use of such products/service in a productive manner, the net effect may be the opposite and likely get worse as more time spent to figure out the products, the less the human productivity and creativity.

Thus, there is a need to develop solutions that address the shortcomings of the current state of the art.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates the situation that a user faces with a confusing marketplace with many choices of products/services and content in both pull and push directions;

FIG. 1B shows a commerce framework in today’s society;

FIG. 1C illustrates the scenario in today’s commerce environment that a user faces with frustration;

FIG. 2A depicts a new paradigm in which a user interfaces with an AI assisted product agent (AAPA) that interacts with a commerce environment on behalf of the user representing the user’s desires/preferences determined via natural language communication with the user, in accordance with an embodiment of the present teaching;

FIG. 2B illustrates the exemplary scope of the natural language communication between an AAPA and a user, in accordance with an embodiment of the present teaching;

FIG. 2C shows exemplary tasks that an AAPA may perform for a user with respect to a commerce environment, in accordance with an embodiment of the present teaching;

FIG. 3A illustrates an exemplary setting in which AAPA interfaces on behalf of a user with products participating in a commerce environment based on knowledge about such participating products according to individual interests of the user, in accordance with an embodiment of the present teaching;

FIG. 3B illustrates exemplary types of information/knowledge that a product participating in a commerce environment may provide to enable interaction with AAPA on behalf of a user to allow personal services and customization of the products to respective users, in accordance with an embodiment of the present teaching;

FIG. 4A depicts an exemplary construct in which a generic AAPA provided in a form of AAPA SDK interfaces with participating products in a commerce environment on behalf of users based on product knowledge exposed by the participating products, in accordance with an embodiment of the present teaching;

FIG. 4B shows an exemplary scheme in which a generic AAPA SDK instantiates multiple instances of the AAPA with respect to individual users to serve as a respective personal product agent for each individual user, in accordance with an embodiment of the present teaching;

FIG. 4C shows a different exemplary implementation in which multiple AAPAs may be instantiated for a user, where each of the APAAs serves the user as a specialized product agent with respect to some product(s), in accordance with an embodiment of the present teaching;

FIG. 5A shows an exemplary setting in which a user communicates with an AAPA to express preferences/interests in a product so that the AAPA operates accordingly to implement/modify the product to meet the user’s preferences/interests, in accordance with an embodiment of the present teaching;

FIG. 5B shows a different exemplary setting in which different users interact with their respective AAPAs to express preferences in different products so that the AAPAs operate accordingly to implement/modify the interested products to meet the respective users’ preferences, in accordance with an embodiment of the present teaching;

FIG. 5C shows exemplary types of communications between a user and an AAPA regarding products, in accordance with an embodiment of the present teaching;

FIG. 6A depicts an exemplary high level system diagram of an instantiated AAPA with a user understanding engine and an execution engine, in accordance with an embodiment of the present teaching;

FIG. 6B is a flowchart of an instantiated AAPA operating to understand a user’s communication via natural language dialogues and carry out tasks to access/design/implement/modify a product based on the user’s preferences, in accordance with an embodiment of the present teaching;

FIG. 6C is a flowchart of an exemplary process of curating personalized content for the user based on continually updated individual interests of the user, in accordance with an exemplary embodiment of the present teaching;

FIG. 7A depicts an exemplary high-level system diagram of a user understanding engine of an AAPA to communicate with a user in a natural language, understanding the user’s needs and queuing tasks to be executed to meet the user’s needs, in accordance with an embodiment of the present teaching;

FIG. 7B is a flowchart of an exemplary process of a user understanding engine of an AAPA, in accordance with an embodiment of the present teaching;

FIG. 8A depicts an exemplary high level system diagram of an execution engine of an AAPA, in accordance with an embodiment of the present teaching;

FIG. 8B is a flowchart of an exemplary process for establishing user-centric information archive in an execution engine of an AAPA, in accordance with an embodiment of the present teaching;

FIG. 8C is a flowchart of an exemplary process for carrying out a task associated with a pull product/service in an execution engine of an AAPA, in accordance with an embodiment of the present teaching;

FIG. 8D is a flowchart of an exemplary process for carrying out a task associated with a push product/service in an execution engine of an AAPA, in accordance with an embodiment of the present teaching;

FIG. 9A depicts an exemplary high level system diagram of a product customization engine, in accordance with an embodiment of the present teaching;

FIG. 9B is a flowchart of a product customization engine, in accordance with an embodiment of the present teaching;

FIG. 9C illustrates exemplary personalized customized product with exemplary types of product features some of which are customized by an AAPA for an individual user, in accordance with an embodiment of the present teaching;

FIG. 10A depicts an exemplary high-level construct of a product that an AAPA may interface to customize certain product features based on a user’s preferences, in accordance with an embodiment of the present teaching;

FIG. 10B is a flowchart of a product in execution to produce customized functions based on function parameters set up by an AAPA based on a user’s preferences, in accordance with an embodiment of the present teaching;

FIG. 11 is an illustrated architecture of a mobile device that may be used to realize a specialized system implementing the present teaching in accordance with various embodiments; and

FIG. 12 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well-known methods, procedures, components, and/or systems have been described at a relatively high-level, without detail, in order to avoid unnecessarily obscuring aspects of the present teachings.

In recent years, the new wave of artificial intelligence (AI) has emerged as a strong force in almost all areas of the society. AI-based product has been deployed in increasingly more applications and emerging as a center force in almost all areas. For instance, business processes are controlled in an intelligent way based on knowledge mined by AI from past operational data by searching for and recognizing underlying patterns embedded in the data representing human experiences and cumulative knowledge. AI significantly improves and shortens the conventional human processes. As another example, AI has been exploited in drug identification, game strategies, malfunction prediction and prevention, trouble shooting in complex systems, dynamic management of data processing schemes, etc. Particularly, the emergence of large language models (LLMs) and generative AI has further enhanced the efficiency and quality in human-machine dialogue that has further lifted the performance of human-machine communications in a variety of applications such as information queries, gathering, creation, inferences, recommendation, and customer services.

While most of the AI based solutions are developed for business systems, products, and applications, the present teaching discloses exemplary methods, systems, and implementations for an AI based product assistance (AAPA) framework for an individual user to carry out tasks personalized to the user according to the user’s needs, which are automatically determined based on communications between the user and the AAPA and/or observations about the user. In this AAPA framework, a user interface may be provided to interact with a user to personally assist the user in a variety of tasks, including understanding the user’s personalized interests via direct communications with the user, curating user interested content based on the user’s personal interests learned via interactions, identifying a product from a commerce environment when it detects there is a need, designing/implementing the product with features according to the user’s chosen or desired features, or modifying some features of an existing product based on the user’s alternative preferences/complaints to generate a personally customized product that the user desires.

The interests/needs/preferences/desires/complaints associated with the user are determined via human-machine dialogues between the AAPA and the user conducted in a natural language. The user’s desires may be ascertained by the AAPA via LLMs (either generic or specialized) to obtain semantic understandings of the intents/desires of the user. In some situations, the user’s desires may be expressly indicated by the user, e.g., mentioning directly that a hotel reservation is needed via two-way communication with the AAPA with relevant information such as destination city, price range, etc. In this situation, the AAPA may identify a product (e.g., a hotel in or near the destination city within the price range) available in the commerce environment to meet the user’s needs and proceed to interact with the identified product to accomplish the task via, e.g., making a phone call to the hotel or interfacing with a hotel broker’s website to secure a reservation and then providing the reservation information to the user. This may also apply to content needed. Based on the interests of the user, the AAPA may formulate automatically a query or a prompt, submit to a content provider/portal/recommender, receive the response result, and pull relevant content associated with the response result.

In some situations, the user’s desires/preferences may be inferred from conversations between the AAPA and the user. For instance, if the user complains about a product, e.g., it is hard to read an online article on the user’s smart phone, the AAPA may suggest and check with the user whether a bigger font size may help. The AAPA may also infer that a brighter screen may help and then take the initiative to modify the product setting to change the current feature setting (e.g., font size or brightness of the screen) to render a personally customized product with desired/needed features (brighter screen and larger font size). The AAPA may carry on a conversation with a user asking the user’s feedback on some content curated by the AAPA and refine the user’s interests based on the user’s feedback. The APAA may also simply monitor the user’s activities in interacting with the curated content to infer the user’s interests. The user’s interests that the AAPA dynamically and continually updates may be utilized to either serve the user in a preferred manner or provided to product/service providers in the commerce environment to enable them to, e.g., personalize their products/services with respect to the user. For instance, a content recommending service may select content in the user’s interests/preferences and then accordingly push such recommendations to the user.

As discussed herein, the AAPA may be configured to customize a product with features personalized based on the user’s desires. In some embodiments, customizing a product to provide a personally customized product to a user may be realized via an interface that the product exposes to facilitate such customization. An AAPA may then operate, on behalf of a user according to the user’s preferences, through the interface to participate in the design or change some existing features in the product by automatically modifying the current settings associated with the product (e.g., change the default font size 10 in the original product to preferred font size 12) to produce the personally customized product for the user.

Each product in a commerce environment accessible by the AAPA as disclosed herein may specify certain customizable product features with information indicated on interface for which modifications may be done. For example, for an online application to recommending local news content, the product features that may be customized may include the source(s) of content (e.g., local news outlets), types of content (e.g., local news, national politics, local weather, local attractions, local crime, etc.), various content delivery options such as font style, font size, interface color hues, or whether presenting the content in text or voice, etc.. For each of these customizable features, the product may expose interface information to facilitate the customization, which may involve, e.g., APIs to various functional modules with parameters thereto, either default or customized. Such information from customizable products in the commerce environment may be stored in a database which may be accessed by an AAPA to determine how to customize each specific product.

The framework according to the present teaching address the common frustration that many users face today. By leveraging AI technologies, the present teaching may be deployed to change the ways to obtain interested content/information/product/services, to develop products, to personalize products, to deliver products, to serve each user in an individually personalized manner. This may be achieved via an AI-based dynamic need-based AAPA that actively participates and in cooperation with products/services in the marketplace in curating content/information, designing and implementing a product, and modifying existing features of a product/service according to individual user’s desire to allow individually customized content/product/service delivered to the user. The present teaching enables automatic personalized curation of interested content, facilitates fast product development via providing skeleton design with placeholder features that can be customized by different AAPAs according to their respective users’ preferences to generate personally customized product versions to different users. This may significantly simplify the product development as compared to the traditional way to do so as the product may be initially developed as a skeleton with some placeholder features that may be instantiated via customization at the time of the use. For instance, assume that a software product (i.e., app) is to curate content from different sources, recommend content to users according to the users’ interests, and display the recommended content on user devices to the users. Traditionally, the app needs to be fully developed by a team of engineers to comply with designs on all aspects or features of the product, including both backend and frontend aspects/features of the product. For instance, the backend operations may include, e.g., setups to different sources for content curation, recommending content to users based on user profiles, monitoring users’ activities with respect to different pieces of content, and algorithms for updating each users’ interests based on the monitored activities, etc.). The frontend operations may include, e.g., designs for graphical user interface (GUI) on different types of devices, layouts of display windows on each type of GUI design, actionable buttons, scrollable mechanism, and user setting interface that a user may interact with to change the default features of the product, etc.

Traditionally, the designs of a product/service on all these aspects may be carried out to allow a fixed look and feel but with some mechanism (e.g., Setting) to allow a user to change certain feel and/or look on some aspects of the GUI within some limited range of alternatives. To cover all these aspects of a product, the product development team needs to spend substantial level of human and capital resources to finish the product development in order to produce the product. Although the setting mechanism may allow users to change the default configuration to specify preferences, most users do not bother to do so because it is often time consuming to figure out how to maneuver to find out what is where to change the default features. In addition, even if a user can figure out how to maneuver the product to make some changes, the choices are often quite limited. Thus, it is expensive to develop a product in a traditional way as described above and such produced products generally cannot satisfy the preferences of many users. With limited choices in changing the settings and the hurdle a user needs to do to achieve that, most products are being used in a way as they are initially designed, despite the fact that many may wish to be able to customize the products according to their preferences to make them more enjoyable or easier.

In contrast, with the framework according to the present teaching, leveraging AI, product development may be made simplified with substantially lower costs. In the meantime, with the APAA described herein, products/services may be offered with configurable design choices which may be made, automatically via the APAA, based on individual user’s preferences/desires. The AAPA according to the present teaching dedicated to each user may obtain dynamic interests of the user via communication with the user in a natural language. Utilizing such learned user’s individual interests, the APAA may assist the user in a variety of tasks in an individually personalized manner, including pulling content of interests, pushing content according to the individual interests, identifying products and personalized product implementation based on user’s needs, customizing existing products based on the user’s needs/desires. In this framework according to the present teaching, a product developer may need to provide merely a product design with structures directed to different functions.

Some of the product functions may be provided with a fixed design. Some functions may be provided as a structures or skeletons operating on a set of placeholder parameters. For this latter class of functions, the product development may focus on the generic processing steps with placeholder parameters so that it minimizes the product development time, effort, and costs. Using the example of an app for recommending locale related content to users based on the users’ locations, the functions that may be fully implemented may include those that no user needs to change, such as the functions for determining a user’s locale, for searching content in different interest areas associated with the locale. Some functions such as those relating to presenting the searched content (e.g., font size, font style, font color, screen brightness, etc.) may be provided as default modules with specified placeholder parameters. For instance, a default presentation style may be provided with the product with a specification as to how many design parameters may be provided as input so that the presentation can change according to the placeholder parameters with values determined based on the input design parameters. In some embodiments, such functions may not even provide a default setting and require input design parameters, i.e., leaving the design parameters to users, and may be invoked with customized design parameters for the placeholder parameters. With respect to a product, its skeleton modules and the placeholder parameters therefor may be exposed (i.e., as a specification) so that an AAPA may accordingly determine the values of the placeholder parameters according to a user’s preferences. In this way, whenever a skeleton module is invoked by the APAA with the values for the placeholder parameters, a customized product may be automatically generated on-the-fly.

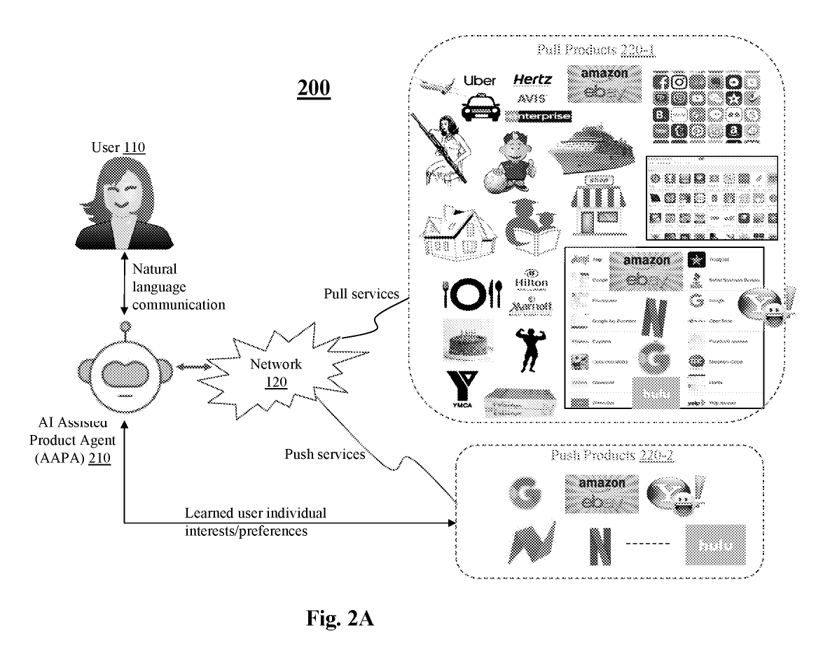

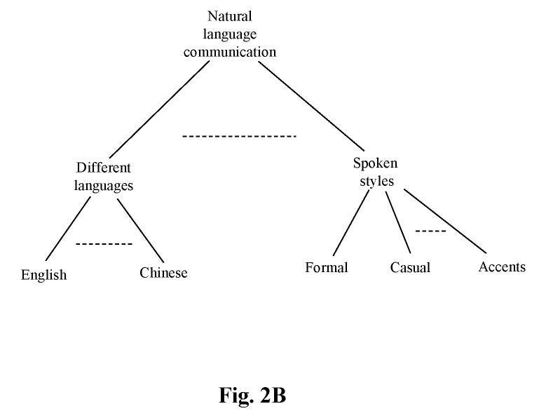

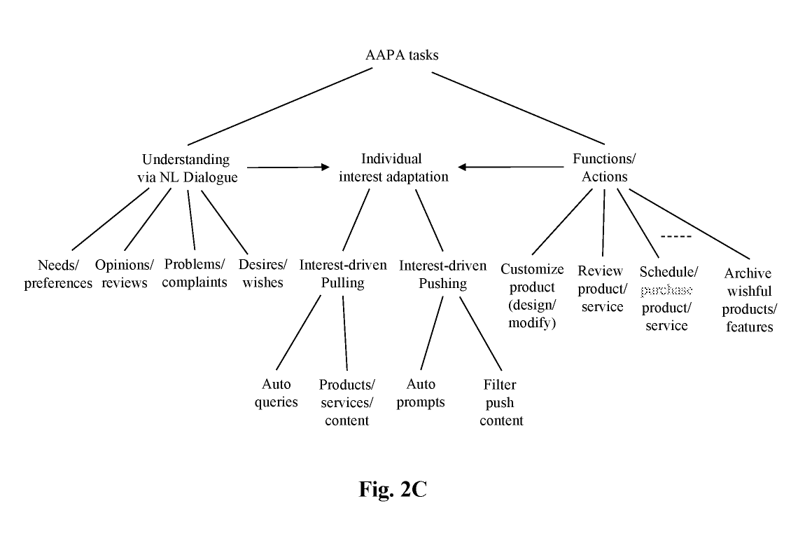

FIG. 2A depicts a new paradigm 200 according to the present teaching. In this paradigm 200, a user 110 interfaces with an AI assisted product agent (AAPA) 210 that interacts, e.g., via a network 120, with a commerce environment 220 that includes various products/services. In some embodiments, the commerce environment 220 includes pull products/services 220-1 for content/products/services via, e.g., search and pulling information. In this illustration, the commerce environment 220 also include a variety of product/services 220-2 that recommend content/products/services via pushing. As discussed herein, a pull product/service in 220-1 may be identified via a search/pulling (i.e., pull the information about product/service via a search), while a push product/service in 220-2 operates by pushing content/product/service to a user via, e.g., recommendations. The push products/services according to the present teaching may make recommendations to a user 110 via the network 120 based on the interests/preferences of the user presented by the AAPA 210 learned through direct interactions/communications with the user 110 conducted in some natural language.

The AAPA 210 acts on behalf of the user 110 to interface with all products in the commerce environment 200 for content/product/services based on the user’s preferences learned over time via natural language communications with the user, in accordance with an embodiment of the present teaching. The products included in the commerce environment 220 may include any businesses that offer products/services to customers via network connections, which may agree to expose respective interface mechanisms therein to facilitate communications with the AAPA 210. Such exposed interface mechanisms are important as they allow the AAPA 210 to interface with any product/service in 220 and act on behalf of the user 110 according to the interests/desires/needs of the user. For instance, the exposed interface mechanism of a product may specify customizable product features, and the APIs used to make customization. The products/services in 220 may correspond to online pull/push products such as those operating on websites, online applications downloadable from different sources such as e-commerce platforms, online commerce platforms, online stores on social media platforms, and those reachable via, e.g., telephonic communications via the network 120. Each of the products in the commerce environment 220 may provide information on its access interface and interactive parameters thereof so that the AAPA 210 may operate accordingly to interface with each of the products included in the commerce environment 220.

For instance, an online app may define its functional modules and parameters thereof so that each of the functional module may be activated or utilized by providing required parameters. A local restaurant (a product) may provide a phone number for making a reservation indicating required parameters related to each reservation including a date, a time, a number of people so that an AAPA may operate as a service robot to make a call on a user’s behave (via, e.g., text to speech) to the restaurant to make a reservation for the user based on the user’s preferred date, time, and the number of people that the AAPA learned from the user via communication with the user.

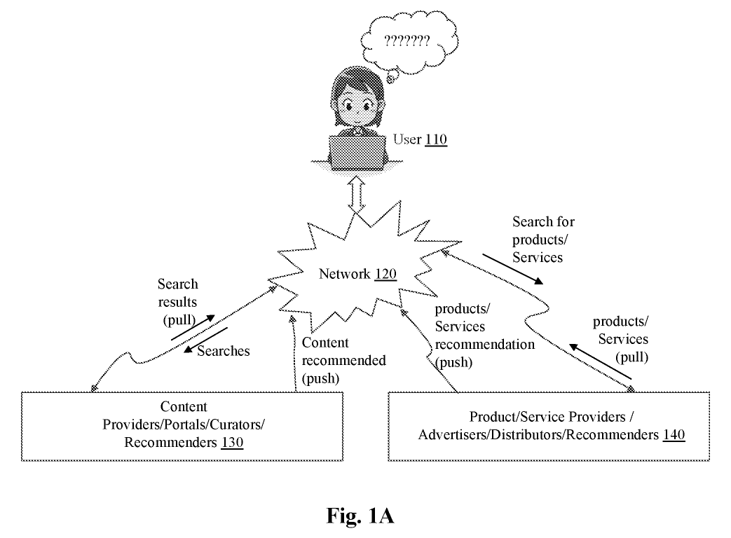

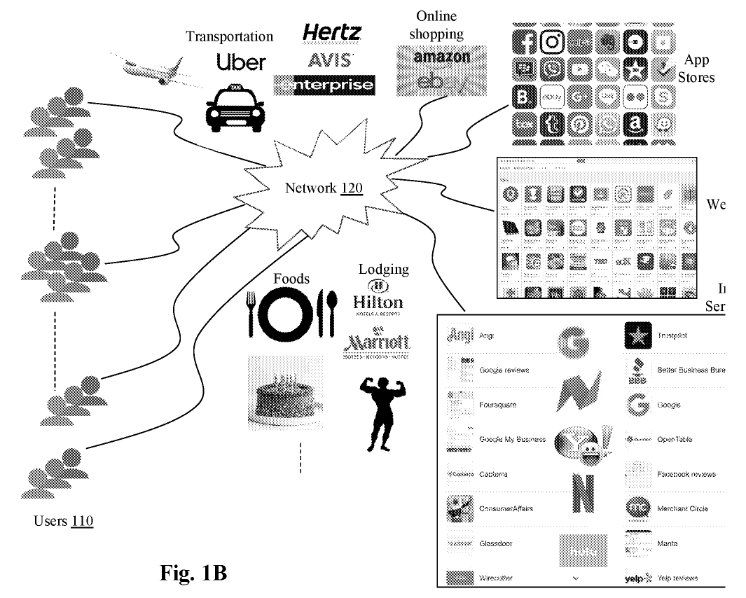

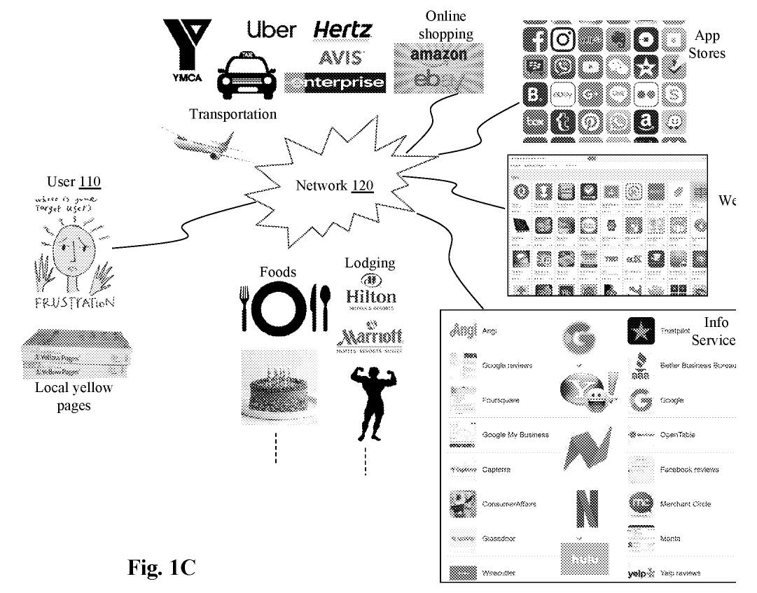

As can be seen in FIG. 2A, instead of facing with all the products in the commerce environment 220 (as shown in FIG. 1C), the user 110 in framework 200 now needs only to interface with the AAPA 210 to let the AAPA 210 know his/her needs/desires/preferences/complaints via dialogues with AAPA 210 in a natural language that the user is comfortable with in connection with the products/services/content the user may need. In addition, via such natural language communications, the AAPA 210 also learns to deliver desired products/services to the user with the user’s preferred functions/features in some language acceptable by the user. This frees users from the confusion of interfacing many products/services and versions thereof, as depicted in FIGS. 1B and 1C, and removes the user’s burden associated with the need to learn how to operate each product/service to get desired products/services delivered in a preferred manner.

FIG. 2B illustrates an exemplary scope of natural language communication between an AAPA and a user, in accordance with an embodiment of the present teaching. With the development of AI, language models (LMs) available today (including small language models or SLM, larger language models or LLM, or multimodal language models or MLM, etc.) can facilitate human-machine dialogues not only in different languages (e.g., English, Spanish, Chinese, etc.) but also in different spoken styles such as different accent, formal speaking style, or casual spoken style, etc. To facilitate the discussion below, LLMs are used as an illustration. It is not intended as a limitation and any other forms of models that may be used for understanding human machine communications may be used. AAPA 210 as illustrated in FIG. 2A is supported by such LLMs, either generic LLMs or specialized LLMs developed in different vertical spaces, to understand not only what is being said despite the language and speaking style in conversations but also the semantics of what a user says to detect the user’s needs/preferences/desires/complaints, etc.

FIG. 2C shows exemplary tasks that AAPA 210 may perform for a user with respect to a commerce environment 220, in accordance with an embodiment of the present teaching. As discussed herein, AAPA 210 may perform tasks in different categories, including those relating to understanding natural language dialogues with users and others relating to taking actions to meet users’ expressed needs. In understanding users via natural language communications, the goal is to understand the users’ needs/preferences, opinions/reviews expressed with respect to certain products/services, problems encountered in using certain products/services, complaints about experience associated with certain products/services, or desires or wishes with respect to some aspects of users’ lives. Based on the understood users’ needs, AAPA may take actions on behalf of the users to meet their desires by, e.g., seeking products/services, participating in product design to customize products/services with functions/features preferred by users, submitting users’ complaints/opinions as reviews to appropriate products/services, scheduling products/services (e.g., reserve dinner at a restaurant), or archiving wished products/services with desired functions/features for product developers (either existing or new) to consider and implement, etc.

To facilitate the AAPA to act on behalf of users with respect to products in the commerce environment 220 in a personalized manner, AAPA 210 may also operate to continually update or adapt the interests of a user based on the ongoing communication with the user as well as the activities/feedback of the user on the content/products/services customized for the user, as illustrated in FIG. 2C. Such adaptively personalized user’s interests may then be used to guide the AAPA 210 to further improve its customized assistance to the user in both pulling and pushing related services. With regard to pull related content/products/services, based on the updated user’s interests, the AAPA 210 may generate automatically search queries to pull information associated with content/products/services that satisfy the user’s interests. With regard to push related content/products/services, the AAPA 210 may accordingly provide updated user’s interests to content/product/service recommendation providers as shown in FIG. 2A to allow them to recommend content/products/services that meet the user’s desire/preferences. In some situations, based on user’s interests in a particular area, the AAPA 210 may generate automatically prompts to obtain content from different third-party AI-enabled tools such as ChatGPT. In addition, when a push product in 220-2 recommends content to the user based on received user’s interests, the AAPA 210 may proceed to filter the pushed content in accordance with the updated interests of the user. In some embodiments, developers of products/services in 220 in the commerce environment may provide information related to their respective products/services to facilitate the AAPA 210 to perform actions to provide their products/services to users according to these users’ needs/preferences.

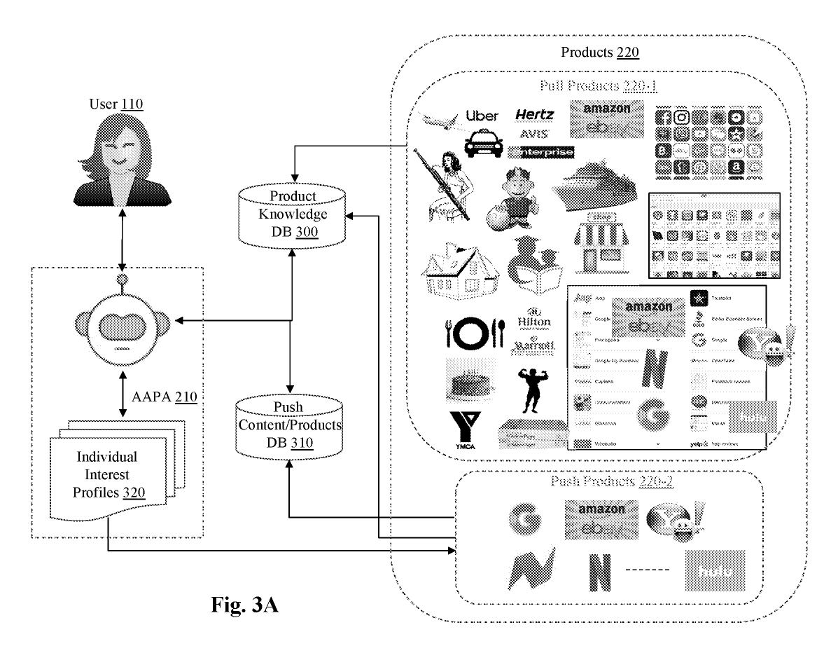

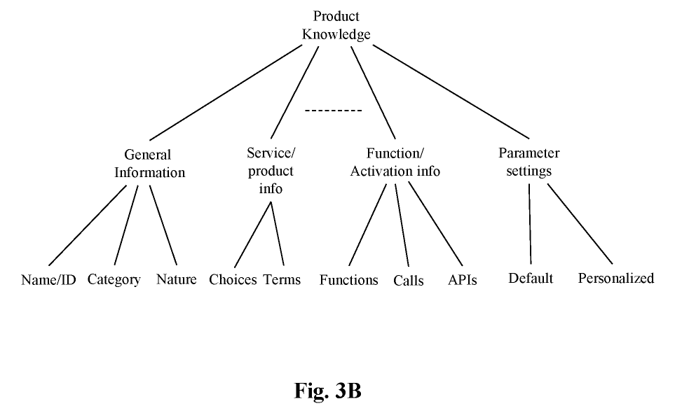

FIG. 3A illustrates an exemplary setting in which AAPA 210 interfaces with products participating in the commerce environment 220 based on information about the products as well as individual interest profile of the user to the AAPA 210 serves, in accordance with an embodiment of the present teaching. In this illustration, the information related to products in 220 is stored in a product knowledge 300 with relevant specification related to different products in 220 to facilitate interfacing, access, and customization of products according to individual interests of respective users. In this exemplary setting, information about products in the commerce environment 220 may be exposed by corresponding developers/operators of such products and is stored in the product knowledge database 300, which may be accessed by AAPA 210 to facilitate its operations with respect to the products 220. Push products that recommend content/products/services to users based on received interests of such users, the content/products/services recommended may be stored in a push content/product database 310. In some embodiments, the recommendation may be made for each individual user according to their personal interests (provided by the personal AAPA for the user) so that database 310 may be with respect to each user to allow the AAPA 210 for each user to access, filter, and deliver to the user at a time that may also be personalized based on the preferences of the user.

FIG. 3B illustrates exemplary types of information/knowledge associated with each product participating in the commerce environment 220 to allow AAPA 210 to interface with it, in accordance with an embodiment of the present teaching. As illustrated, knowledge associated with a product may include general information about the product, specific information about how the service/product operates, information about some functions exposed and details on the activation thereof, and input parameters needed by different functions, and an indication about which of the functions/parameters that may be customized. General information may include a name or an identifier of the product, the nature of the product (e.g., an online app for recommending content of a locale where a user), a category of the product (e.g., the online app for recommending local content may belong to the category of products on content recommendation). Information about the offering of a product may include choices of the product (e.g., different versions) and terms associated therewith. For example, an online local news recommendation app may have different versions (e.g., basic version for just local news, second level may include additionally local entertainment facilities, etc.) and terms associated with each (e.g., basic version may cost less than the second level product). The information about some product functions and activation thereof may be provided to enable others such as AAPA 210 to interface with the product. With such information, the AAPA 210 may operate to participate, on behalf of users, in the design or modification of certain features of some functions according to users’ preferences. In some embodiments, such information may include a list of product functions and indication of how to invoke each function. For example, for a software product, each function may be exposed as an application programming interface (API) which may be used to call to carry out the function. If a product is an offline service such as a restaurant, the functions may include normal meal, wedding events, etc. and for each, there may be a contact information such as a phone number that may be used to establish the needed services.

For each exposed function, there may be corresponding parameters associated therewith, some of which may be product-specified as default, and some may be personalized. The default parameters may or may not be personalized, depending on the setting. In one example, a product of an online app for recommending local content may have certain functions exposed in the commerce environment so that they may be customized by AAPA 210 with user preferred parameters provided as part of the product design. In this example, the product functions for rendering digital content on a device may be customized using user preferred settings, e.g., font style, font size, color, real estate layout, etc. In another example, if a product provides services at a party venue, exposed functions may include services to different event types (e.g., birthday, family gathering, graduation party, etc.), each of which may be performed based on parameters such as date, time, a number of attendees, party supplies such as food and drinks, etc. Such parameters are specified before reserving the services ahead of date/time to activate the services with received parameters. By exposing such information needed for each product in the product knowledge database 300, the AAPA 210 may accordingly gather details needed to activate certain product functions from the users according to their preferences via the natural language communication as discussed herein. Based on such accordingly gathered information, the AAPA 210 may interface with the product to perform different functions on behalf of users, such as to sign up, to design, to customize some function of the product by providing parameters for the functions that meet the users’ preferences to yield a dynamically customized product/service.

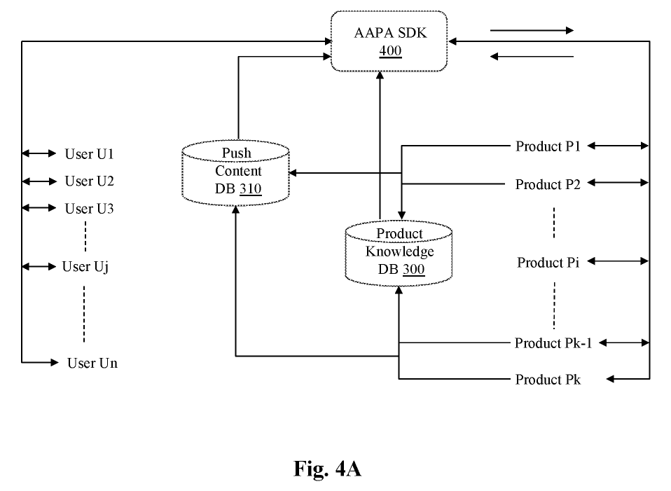

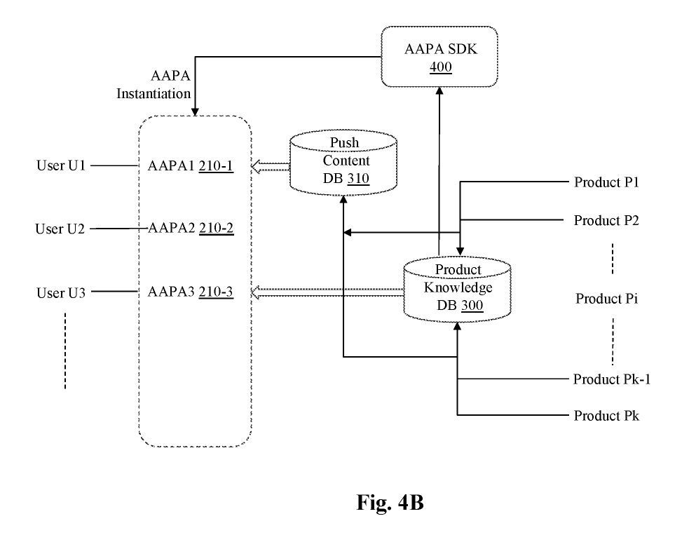

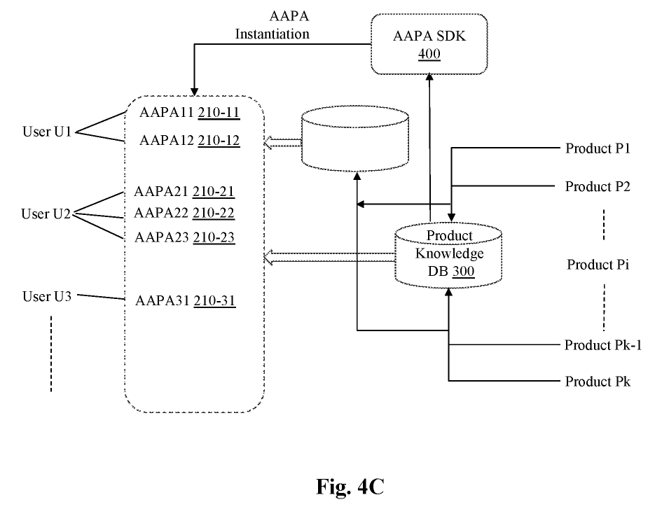

FIG. 4A depicts an exemplary architecture in which a generic AAPA provided in a form of AAPA SDK 400 may interface with products in a commerce environment 220 on behalf of different users based on product knowledge exposed by the products, in accordance with an embodiment of the present teaching. As shown, in this setting, the AAPA SDK 400 is provided to communicate with a plurality of users U1, U2, …, Un to understand their needs/preferences/interests/desires, select relevant products/services in 220 based on individual user’s interests, and interface with selected products P1, P2, …, Pk according to product knowledge stored in database 300 to carry out tasks preferred by each individual user. Some push products may make recommendations to users according to their individual interests, the recommended content (e.g., online articles/products/services) may be stored in a push content database 310. The recommended content is also accessible to the AAPA SDK 400 to filter the recommendations with respect to each individual user according to their individual preferences. In this manner, each user interacts with the AAPA on needs for different products/services and the AAPA fulfills such needs by acting on behalf of the user to seek, curate, design, configure, or modify appropriate content/products/services and deliver the same to the user with functions/features that the user prefers.

FIG. 4B shows an exemplary implementation of the architecture in FIG. 4A, in which the generic AAPA SDK 400 may instantiate an instance of a special AAPA with respect to each user to serve as a dedicated personal AAPA for the user, in accordance with an embodiment of the present teaching. While the generic AAPA SDK 400 is connected to the product knowledge database 300 with full knowledge of the information on products participating in the commerce environment 220, when it comes to each user, a special AAPA may be instantiated based on the AAPA SDK 400 to operate in a manner dedicated to the user. In this way, the special AAPA operates specifically for the user it is dedicated to and possesses the full knowledge needed to interface with any of the products in the commerce environment 220 so that it is equally powered with respect to any of the products in 220. In the meantime, as it is an instantiation specifically for the individual user, this special AAPA may serve as the personal AAPA dedicated to this user by communicating with the user to learn a unique way to interact with this user (e.g., language, accent, habits, etc.), to understand the personal needs/desires/dislikes, to remember specific events meaningful to the user (e.g., user’s birthday, his/her children’s birthdays, anniversaries, etc.), and to become adaptive to the changing interests of the user to dynamically handle the user’s needs in order to enhance the performance in assisting the user. As illustrated, for user U1, the AAPA SDK 400 instantiate an instance 210-1 for user U1, which operates as a dedicated AAPA for user U1. Similarly, for user U2, an instance 210-2 is instantiated for user U2, which operates as a dedicated AAPA for user U2. Each of the instantiated AAPA instance for a particular user may operate to interface with products/services in the commerce environment 220 on behalf of the user based on information stored in the product knowledge DB 300 in accordance with the needs of the user. In addition, for push related products/services, the instantiated AAPA for each user may act on behalf of the user to retrieve the pushed content stored in the push content DB 310 relevant to the user it is dedicated to and deliver the pushed content to the user.

FIG. 4C shows a different exemplary implementation in which different AAPAs may be instantiated for the same user, each of which serves for the user as a specialized product agent with respect to some product(s), in accordance with an embodiment of the present teaching. AAPA SDK 400 may include different specialized AAPA capabilities. For instance, some may be equipped with specialized capabilities in dealing with some types of products/services. For example, some may be especially fit for dealing with software products/services. Some may be specializing in working with content recommendation products/services to ensure of regular update of changing user’s interests, communicating with content recommendation products on the same, and ensure that content appropriate for the user is recommended. Some may be especially designed for dealing with offline products/services which interface with users via, e.g., calls so that such specialized AAPA may be equipped with, e.g., the ability to make calls using text-to-speech to communicate with products/services (e.g., hotels, rental cars, restaurants, theaters, etc.). With different types of specialized product agents available at AAPA SDK 400, different AAPAs may be instantiated to the same user, depending on the needs of the user. This is shown in FIG. 4C, where user U1 is associated with two instantiated AAPAs, i.e., 210-11 and 210-12 for handling different specialized tasks. Similarly, user U2 is associated with three instantiated AAPAs 210-21, 210-22, and 210-23. Each of the APAAs instantiated for the same user may operate to assist the user on specialized tasks. In some embodiments, different AAPAs may be coordinated via some higher level AAPA specialized in coordinating among multiple specialized AAPAs to schedule actions by different AAPAs based on the nature of the tasks in hand.

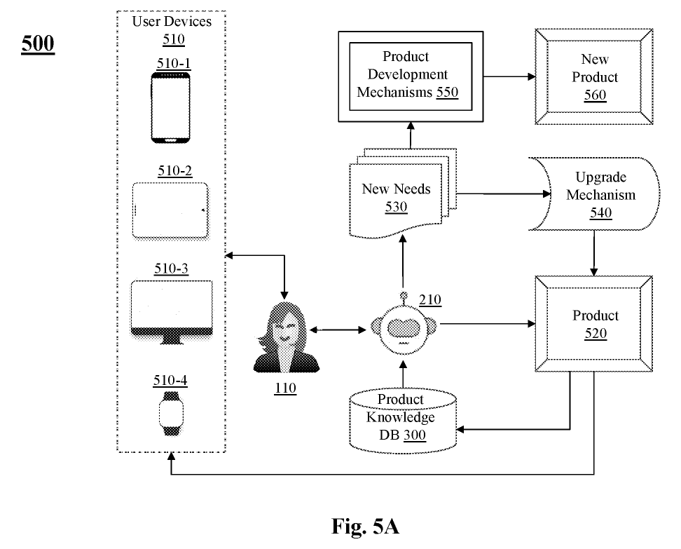

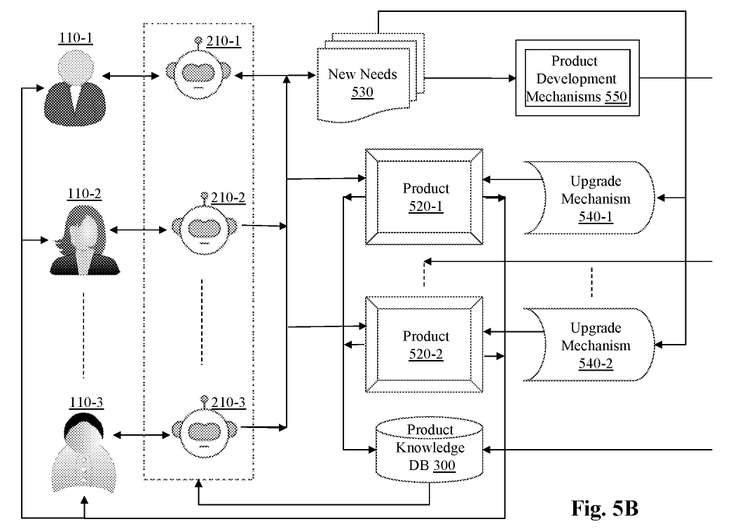

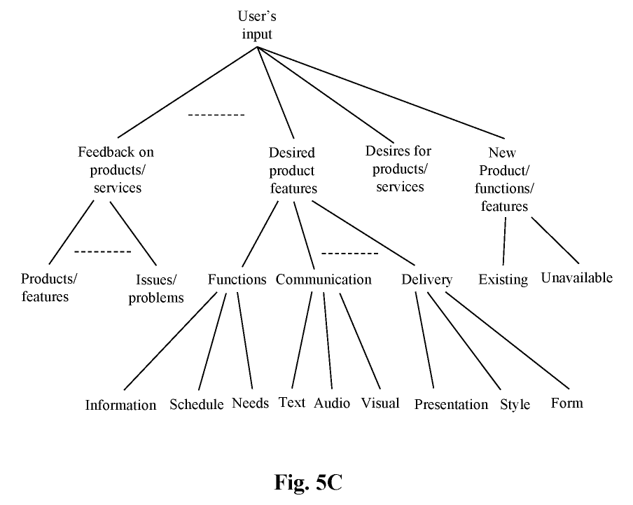

FIG. 5A shows an exemplary setting 500 in which a user 110 interacts with an AAPA 210 (e.g., instantiated for the user) to express preferences/interests in a product 520 so that the AAPA 210 operates to design/implement/modify the product 520 to create a customized product that meets the user’s preferences/interests, in accordance with an embodiment of the present teaching. In this exemplary setting 500, the user 110 may express different interests via different user devices 510. For example, if the user has a smart phone 510-1, a tablet 510-2, a computer 510-3, and a wearable watch 510-4. The user 110 may desire to view local headline news on a user device via an online app that recommends local content that pushes content based on the location of the device. In this case, user 110 may subscribe this service on each of the devices that the user 110 may use so that no matter where the user goes with which of the devices in 510, the user may receive the recommended local content. For instance, when user 110 is at home, the computer 510-3 or 510-2 may be used to view the recommended local content. But if the user goes to a gym, the user 110 may take only the wearable watch 510-4. But when the user does to hiking, the user may take a smart phone 510-1 for the trip.

In this example, the user 110 may desire to configure each of the device differently due to different real-estate characteristics on each device so that the recommended local content may be displayed in an appropriate way. For instance, while at home, the user 110 may configure to receive the recommended local content in text form with respective font sizes on the tablet 510-2 and on the computer 510-3. But if the user is out hiking with the smart phone 510-1 or exercising with the wearable watch 510-4, the user may prefer that the recommended local content is delivered via voice so that the user can simply listen to it. To achieve that, the user may communicate with AAPA 210 to express the preferences of receiving recommend local content from the online product 520 and the AAPA 210 may then interface with product 520 (in different versions, e.g., a computer version, a tablet version, a smart phone version, and a wearable watch version due to different real-estate availabilities on different devices) to customize the product to produce different customized products to operate on different devices to deliver services in the respective desired manner.

In some situations, some functions that a user desires in a product may not be available. In some situations, the features preferred that a user prefers in some function of a product (e.g., deliver recommended content in audio form) may not exist. Such situations may be determined by the AAPA 210 by comparing what the user 110 desires with available functions/features specified in the product knowledge in database 300 associated with the product 520. If it detected that some desired function/feature is not provided by a product in its current form, the AAPA 210 may archive the unfulfilled desires/preferences in a storage for new needs 530. In some embodiments, the new needs may be archived with respect to different products. For instance, unfulfilled functions/features associated with an example online local content recommendation product may be stored with respect thereto and marked as such in the storage for new needs 530. In some situations, users may also expressly request some products that are simply not available in the commerce environment. Such an unavailable product may be available in the marketplace but not participate in the commerce environment 220. Alternatively, the unavailable product may correspond to one that no one has developed it yet. In this case, a new need for a new product not yet available may also be archived as the wishful but non-available category. The archived new needs may be accessed by product developers associated with products in the commerce environment 220 to, e.g., upgrade, via an upgrade mechanism 540 associated with each product, their respective products by adding those unavailable functions/features desired by users. For the new needs archived for unavailable products, some entrepreneurs or companies may pick up such needs to develop, via a, e.g., product development mechanism 550, new products 560 to respond to the market needs.

FIG. 5B shows a different exemplary setting in which a plurality of users 110-1, 110-2 - 110-3 interact with their respective AAPAs 210-1, 210-2 - 210-3 to detect their respective needs/preferences in different products 520-1 – 520-2 so that the AAPAs operate to implement/modify relevant products to meet the users’ desires, in accordance with an embodiment of the present teaching. Similar to what is discussed with reference to FIG. 5A, unavailable functions/features desired by different users are archived as new needs 530, which may be organized with respect to each of the products in the commerce environment 220 or as new products. Based on such organized information, the product upgrade mechanisms associated with the individual products may access the archived needs to make determinations on whether to upgrade the respective products to incorporate additional functions/features. In some embodiments, such new functions/features may be made available by providing a skeleton implementation with specified parameters, some default and some customizable based on the archived needs. Information about the archived desired new products yet unavailable in the marketplace may be made accessible to the marketplace so that third party companies may develop some of the new products to meet the demands.

FIG. 5C shows exemplary types of inputs from a user while in communication with an AAPA regarding certain products, in accordance with an embodiment of the present teaching. In some embodiments, user inputs may be classified or categorized with respect to actions that APAA 210 may take to meet the user’s needs via interface with relevant products. For example, inputs may relate to users’ feedback on some products (e.g., the window for display recommended content is too small), users’ desires for product functions/features (e.g., recommended content be read in audio), users’ needs for certain products/services (e.g., ask for an online product for teaching children math), users’ expressed wish for certain products that are currently unavailable in the marketplace (e.g., suggest someone to develop an online speech therapy product), or more personalized features in an existing product (e.g., a user may complain that it is hard to read the content displayed on a device screen, i.e., the user desire to see a bigger font size).

Some categories may be further divided into sub-categories. For instance, with respect to a category of user input regarding users’ feedback on products, the feedback in this category may be further divided into sub-categories of feedbacks (problems/issues) on specific functions/features associated with certain products/functions. The user input in a category directed to desired product features may be further divided into different sub-classes, e.g., desired functions in products, desired form of communication, …, or desired manner in which services are delivered. Desired functions may be related to different aspects of products/services. For instance, some users may desire to get certain types of information (e.g., news on headline stories) from some desired sources (e.g., Wall Street Journal and Washington Post), some may prefer to receive searched/recommended content at some scheduled times of each day and content be delivered to the user at such scheduled times. The archived needs may also include preferred functions/features related to communication. Some users may prefer communication be conducted using text, some may prefer via voice, and some may prefer visual. The users’ preferences/desires/needs are detected by the AAPA in communication with users in natural language by understanding what users said, did, or reacted in different settings and then classifying such understood users’ input into different categories of needs of different users.

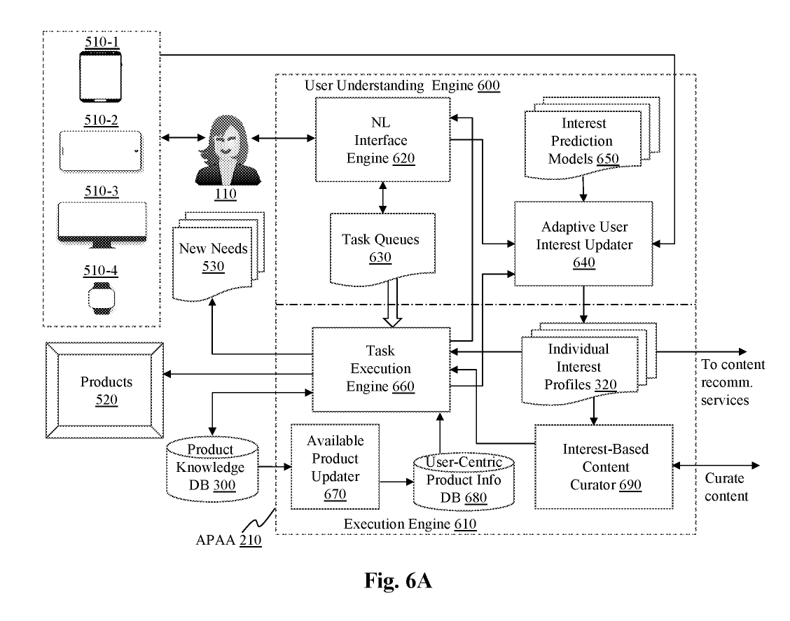

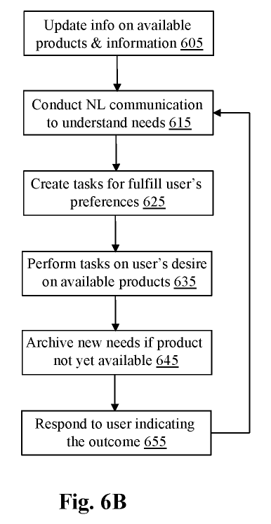

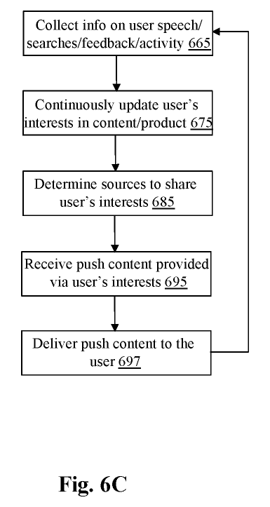

FIG. 6A depicts an exemplary high level system diagram of an instantiated AAPA 210 having a user understanding engine 600 and an execution engine 610, in accordance with an embodiment of the present teaching. In this exemplary embodiment, the instantiated AAPA 210 comprises two main functional parts. One corresponds to the user understanding engine 610 for communicating with a user in natural language to understand the user’s needs/desires/preferences/interests. The other corresponds to the execution engine 610 for performing actions to carry out tasks to fulfill the needs/desires of the user. In this illustration, the user understanding engine 600 includes a natural language interface engine 620 and an adaptive user interest updater 640. The natural language interface engine 620 is provided to interact with a user 110 to understand what the user said based on the user inputs and create tasks that need to be performed by the execution engine 610 and queue the tasks in task queues 630. The adaptive user interest updater 640 is provided to recognize, based on interest prediction models 650, different needs/desires/interests of the user in different topics/categories based on what the user said, and update the individual interest profiles 320, which are used in executing different tasks.

The execution engine 610 is provided for executing tasks queued in task queues 630. For instance, some tasks may be to interface with different products in the commerce environment 220 according to the product knowledge in database 300 to ensure that the user’s needs/desires are taken care of in a manner according to the individual interest profiles 320. In this illustration, the execution engine 610 comprises a task execution engine 660, an available product updater 670, and an interest-based content curator 690. The available product updater 670 may be provided to regularly search in the product knowledge database 300 to get an update on products remaining available in the commerce environment. This may be needed because previously available products may be terminated and new products that newly participate in the commerce environment may be added. In some embodiments, an AAPA 210 instantiated for a particular user may elect to include therein a local user-centric product information database 680, which may store information related to products/services relevant to the user. In this setting, the AAPA 210 may maintain a list of products/services that the user is using and store related information specific to the user and update the local information continuously based on the product knowledge in database 300.

The task execution engine 660 may be provided to carry out the tasks queued in 630 based on communications with the user 210 to fulfill the needs/desires of the user. When a task is to sign up with a new product/service for the user and the needed product/service, the task execution engine 660 may check its availability via the product knowledge database 300. If the needed product/service is available, the task execution engine 660 may interface with the product according to the knowledge related thereto to, e.g., implement personal preferences with respect to the product to produce a personally customized product. The preferred product functions/features associated with the product/service may be stored as the user-centric product information in local database 680. If the needed new product/service is currently not available in the commerce environment, the task execution engine 660 may store the need for a new product/service in storage for new needs 530.

Some of the queue tasks may related to content curation and presentation. For instance, a user may be interested in receiving local news every morning and the preferred delivery style associated with the user may be to read the local new in audio form while the user is getting ready to go to work in weekday mornings. Given that, a corresponding task queued in 630 may be executed by the interest-based content curator 690, that proceeds to curate local news each morning by receiving, e.g., local news recommended by a local content recommender application and then converting, according to the recorded individual interest profile 320, the text form of the recommended local news to the user in audio form.

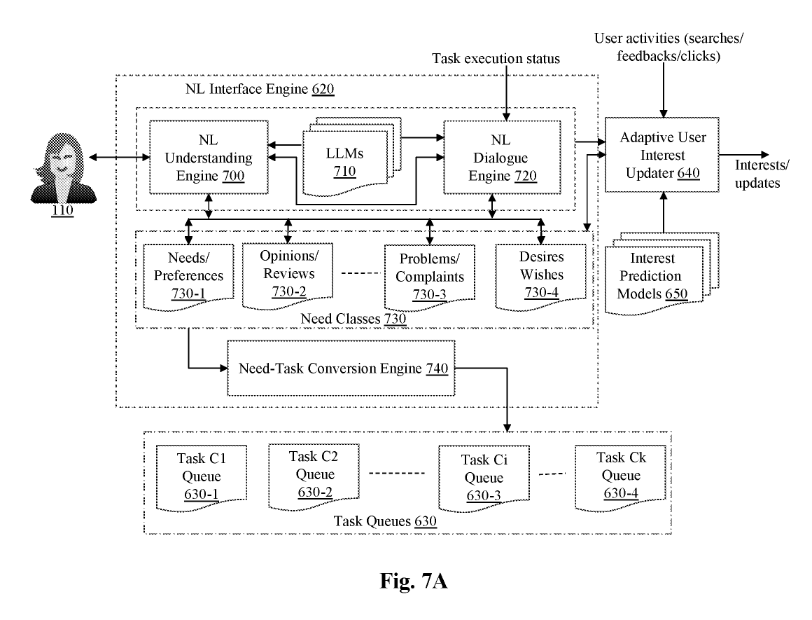

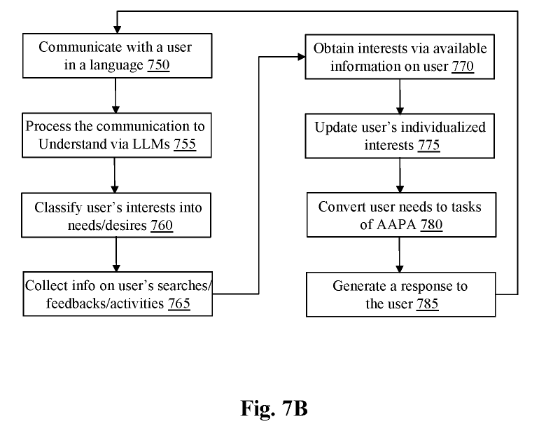

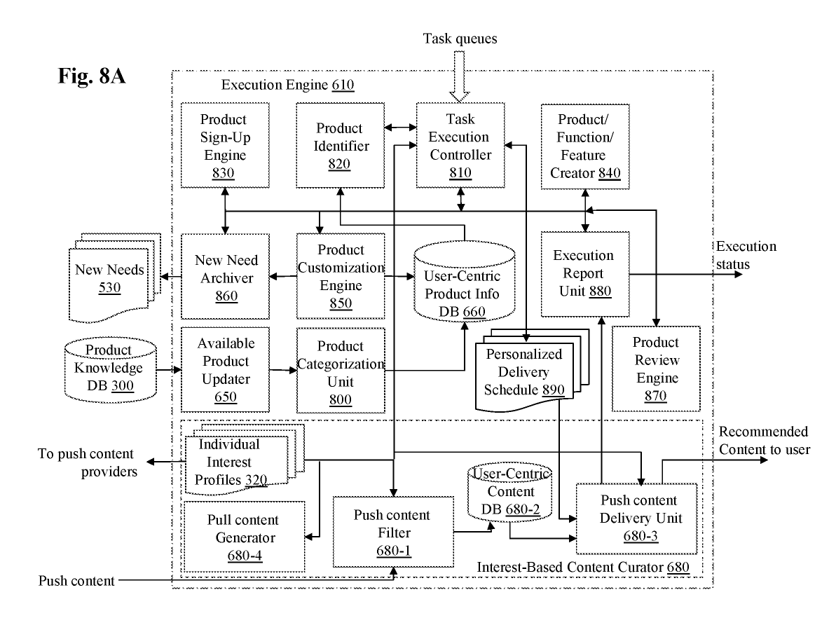

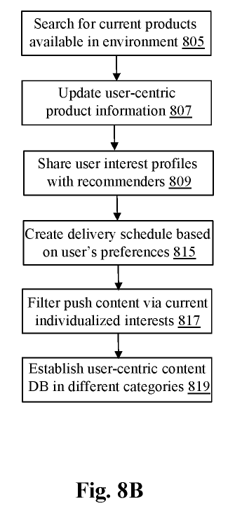

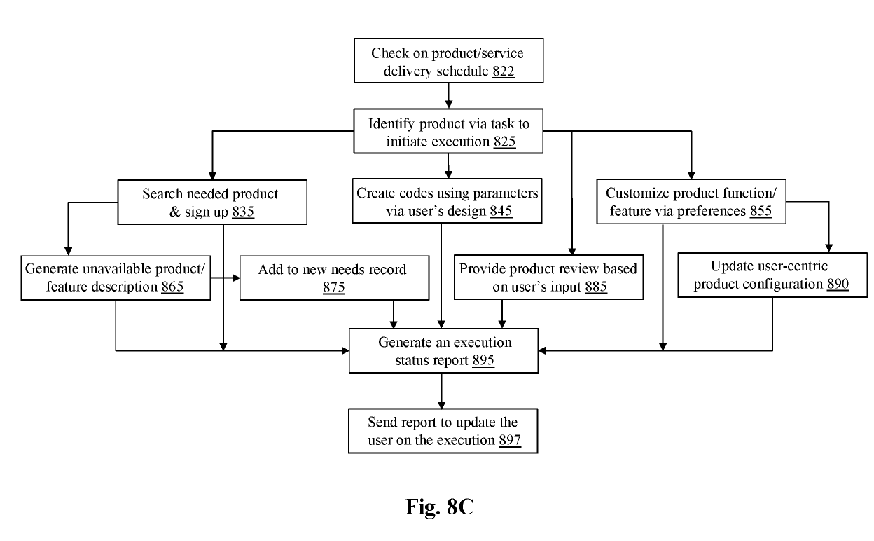

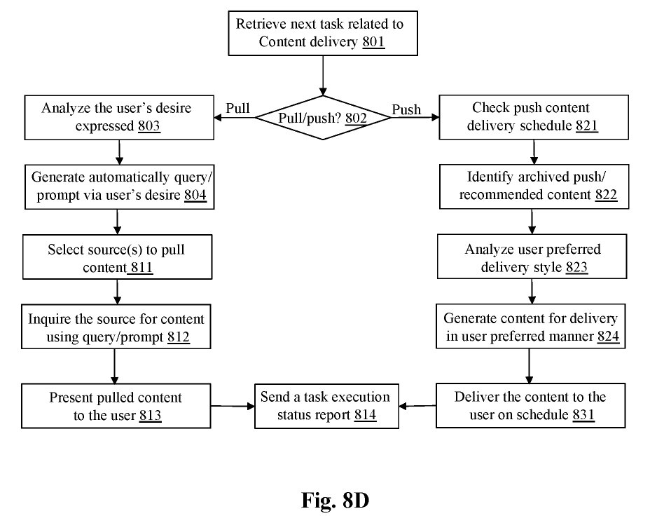

FIG. 6B is a flowchart of an AAPA 210 operating to understand a user’s communication via natural language dialogues and carry out relevant tasks to access/design/implement/modify a product based on the user’s preferences, in accordance with an embodiment of the present teaching. As discussed herein, products/services participating in the commerce environment 220 may be updated with some products/services leaving the commerce environment and some new ones added to the commerce environment. Given that, the AAPA 210 may regularly update, at 605, knowledge about what are new, what are still available, and what are gone and accordingly update the content in the user-centric product information in local database 680. To assist a user, the AAPA 210 communicates with the user in a natural language at 615, determines the user’s needs/desires based on natural language processing, and creates, at 625, tasks to be carried out by the task execution engine 660 by performing, at 635, such created tasks with respect to products/services on behalf of the user to design/implement/modify the relevant products/services. If a task involves a new product/service (i.e., no existing product/service for that need is found in the current commerce environment) or a new function/feature associated with an existing product/service, the task execution engine 660 archives, at 645, the new need so that some entity may choose to address the new need to either add the desired function/feature to the existing product or provide a new product/service as requested. Based on the status of the execution of tasks, the task execution engine 660 may provide such status information to the NL interface engine 620 so that it may respond, at 655, to the user with the execution status. Details related to the NL interface engine 620 are provided below with reference to FIGS. 7A – 7B. Details related to the task execution engine 660 are disclosed with reference to FIGS. 8A – 8B.

FIG. 6C is a flowchart of an exemplary process of curating personalized content for the user based on continually updated individual interests of the user, in accordance with an exemplary embodiment of the present teaching. As discussed herein, based on the communications with the user in a natural language, the individual interest profiles 320 is established continually during interaction between the AAPA 210 and the user and are continually updated based on both the communication and on information collected, at 665, that is indicative of the user’s activities such as searches performed, feedback exhibited on search result, and engagement on different piece of information . The individual interest profiles 320 of the user may then be continuously updated in connection with user’s interest in content/product at 675. Based on the updated interests in content/product, sources representing content recommendation services are determined at 685 so that the updated individual interest profiles associated with the user may be shared and transmitted to the sources. With the updated user’s interest profiles, different content recommendation applications/products may push content to the user. When the interest-based content curator 690 receives, at 695, the pushed content recommended based on the user’s interests, it delivers, at 697, the recommended content to the user according to the user’ preferred style.

FIG. 7A depicts an exemplary high-level system diagram of the NL interface engine 620 for communicating with a user in a natural language, understanding the user’s needs, and generating tasks to be executed to meet the user’s needs, in accordance with an embodiment of the present teaching. In this illustrated embodiment, the NL interface engine 620 is depicted in connection with other components in the user understanding engine 600, including the adaptive user interest updater 640 and the task queues 630. In this embodiment, the NL interface engine 620 comprises a natural language (NL) understanding engine 700, a NL dialogue engine 720, and a need-task conversion engine 740. The NL understanding engine 700 is provided to analyze the user’s input in a natural language and to understand what the user said in terms of the user’s needs/desires and then to archive such recognized user’s needs/desires into different need classes 730, as discussed herein. As shown, the user’s input may be recognized or inferred to be the user’s needs/preferences (730-1), the user’s opinions/reviews of some product/service (730-2), …, the user’s problems/complaints about certain product/service (730-3), and the user’s desires/wishes for some new functionalities of some product/service or new product/service (730-4).

The NL dialogue engine 720 may be provided to carry on a conversation with the user by, e.g., asking questions to the user, responding to questions from the user, verifying the understanding of what the user said, or reporting a status of handling a request regarding a product/service. Both the NL understanding engine 700 and the NL dialogue engine 720 may operate based on LLMs 710, which may be an off-the-shelf product or developed specifically based on an application. In some embodiments, the NL understanding engine 700 and the NL dialogue engine 720 may be integrated/merged as a conversional engine operating using ChatGPT like technologies. Based on the continued understanding of the user’s needs/preferences/interests (as in different classes in 730), the adaptive user interest updater 640 may leverage the updated understanding to update the user’s interest profiles. As discussed herein, in some embodiment, the adaptive user interest updater 640 may also monitor the user’s activities directed to different content/product/service and features thereof and infer, based on the interest prediction models 650, the needs/preferences/interests of the user and update, accordingly the content in the 730 as well as the individual interest profiles 320 associated with the user.

As discussed herein with reference to FIG. 5C, different needs/desires/complaints may be identified from the user’s input and may be classified into different need related classes 730, as shown in FIG. 7A. Based on such classified needs, the need-task conversion engine 740 may be provided to map different needs to corresponding tasks to be carried out to address the needs. For instance, if the user complains that it is hard to read the content recommended by a local content recommendation app and displayed on a device, via natural language understanding (by the NL understanding engine 700), the NL dialogue engine 720 may inquire whether the user would like to enlarge the font size. If the user confirms, then the need is to have the product to display recommended content with a customized font size and the corresponding tasks converted from this need is to customize the display function of the app for recommending local content with a user preferred font size. As needs are classified, their corresponding tasks may also be converted into groups, each of which may have multiple tasks queued, as shown as task queues 630 in both FIG. 6A and FIG. 7A.

FIG. 7B is a flowchart of an exemplary process of the user understanding engine 600 of an AAPA, in accordance with an embodiment of the present teaching. During a conversation at 750 between AAPA 210 and the user in a natural language, the NL understanding engine 700 analyzes the communication, at 755, to understand the semantics of the user input via natural language processing based on, e.g., LLMs. Such understanding may be utilized to recognize the user’s needs/preferences/interests/opinions, etc. and classify, at 760, the recognized user’s expression into different classes 730 as shown in FIG. 7A. At the same time, the adaptive user interest updater 640 continuously collects, at 765, information about the user’s activities (searches/feedbacks/clicks/engagements, etc.) and obtains, at 770, the user’s ongoing interests/preferences which may then be used to update, at 775, the individualized interests in both the need classes 730 as well as the user’s individual interest profiles 320. Based on different classes in 730, the need-task conversion engine 740 then converts, at 780, different needs/views/issues/desires detected from the user’s communication and activities into corresponding tasks that are to be carried out by the AAPA 210 with respect to different products/services. According to the classified needs, the NL dialogue engine 720 may generate, at 785, a response to the user. Such a response may include a question directed to the user requesting to confirm a detected or an inferred interest/preference/opinion/desire.

As discussed herein, a commerce environment 220 includes a plurality of products, some of which correspond to pull products/services 220-1 i.e., obtained via a search or a contact) and some to push products/services 220-2 (i.e., that push content/products/services as recommendations to users). Some of the products in 220-1 may expose relevant information to outside world, allowing an AAPA according to the present teaching to interface with the product on behalf of a user to select, to sign up, to configure, to customize, to opine, or even to create new function/services. With respect to such customizable products/services in a commerce environment, the generic AAPA (or AAPA SDK) or its instantiations may serve as a personal product assistant to each user to interface with such a product/service to design/implement/customize the product/service. This may take the burden off each user when it comes to how to leverage a vast range of available products/services without frustration based on the product knowledge about each product/service that the AAPA is made aware. The generic AAPA communicates with a user in a natural language to gain understanding of the user’s needs/desires/complaints and utilize its knowledge about the products to assist the user in a personally customized manner by carrying out automatically in, e.g., product/service selection (from a large pools from different sources), product/service sign-up, product/service configuration, product/service customization according to the user’s preferences, and in some scenarios such as software applications, even creating new products/functions/features by automatic generation software codes that are parameterized according to a user’s needs/preferences. As discussed herein, the NL understanding engine 600 is for conducting natural language communication with a user to gain understanding of the user’s needs/desires and to create tasks to be carried out for fulfill the user’s needs/desires. The execution engine 610 is provided for carrying out such tasks and implement automated solutions to deliver products/services to satisfy the user’s needs/desires.

FIG. 8A depicts an exemplary high level system diagram of the execution engine 610 of an AAPA, in accordance with an embodiment of the present teaching. As discussed herein, the execution engine 610 is provided to carry out tasks to address the needs/desires of a user and such tasks may be classified into different types, each of which may include one or more queued tasks. For example, a type of tasks may be to customize a product to add/modify some functions/features of a product according to user’s desires. Another type of tasks may be to identify a product/service for the user based on a wish expressed by the user in communication with an AAPA. Yet another type of tasks may be to provide the user’s feedback or opinions on some features or functions associated with some products/services, etc. Another type of tasks is related to push related products/services. For instance, a task may be to summarize the content recommended by a local news recommender service to ensure that the summarized content may be delivered in a certain amount of time preferred by a user (e.g., the user may specify to deliver local news each morning in 0.5 hours while the user is preparing to go to work each morning).

Each type of tasks may be executed by specialized modules. As shown in FIG. 8A, this illustrated embodiment comprises a product categorization unit 800 for classifying products/services associated with the user into different categories to properly providing assistance to the user, a task execution controller 810 for receiving tasks from different queues and directing each task to an appropriate execution module, an execution report unit 880 for generating a report on the status of tasks executed to take care of the needs/preferences/desires, and a number of task specific modules for carrying out respective tasks. These modules include a product identifier 820 for identifying a product/service to satisfy a user’s need, a product sign-up engine 830 for signing up on behalf of the user an identified product/service, a product/function/feature creator 840 for designing/creating automatically a product with functions/features that the user desires, a product customization engine 850 for customizing some function/features in a product that the user is using, a new need archiver 860 for identifying a new need from the user and archive it for future development, a product review engine 870 for acting on behalf of the user to provide opinion/review directed to a product/service based on an understanding of the user’s view from the natural language communication therewith, and the interest-based content curator 680 provided for automatically curating content according to the individual interest profiles 320 adapted dynamically. The interest-based content curator 680 includes components for content services in terms of both pull and push manners, including a push content filter 680-1 for filtering push content received from push content recommenders and storing the filtered content in a user-centric content database 680-2, a push content delivery unit 680-3 provided for delivering content from some content recommending services to the user according to the user’s preferred style specified in the individual interest profiles 320 as well as personalized preferences as to delivery time recorded in the personalized delivery schedule 890, and a pull content generator 680-4 provided for pulling content based on a query or a prompt automatically generated based on the request of the user from appropriate sources.

FIG. 8B is a flowchart of an exemplary process of the execution engine 610 of an AAPA to maintain user-centric information needed to assist the user, in accordance with an embodiment of the present teaching. As discussed herein, the AAPA may regularly update the product knowledge of the products/services participating in the commerce environment by searching, at 805, currently products/services participating in the commerce environment. If during the search, any additional products/services are identified or any previously existing products/services in the commerce environment has been removed, such updated knowledge is used to update, at 807, the user-centric product information in 660. This update process may be carried out regularly and continuously so that the execution engine 610 of the AAPA may operate with the correct information about the commerce environment accordingly.

On the other hand, similar to maintain an updated version of the user-centric product information in 660, the execution engine 610 may also operate to maintain an updated user-centric content database 680-2 as well as a user’s desired schedule to deliver what is desired on content/products/services. In some embodiments, according to the preferences of the user on, e.g., the length of the content to be delivered at some preferred time slot with limitations, the execution engine 610 may also filter the content pushed to the user according to the updated user interest profiles and archive such processed content before it is delivered. As illustrated in FIG. 8B, to automatically curating content and process the same for scheduled delivery, the user’s individual interest profiles 320 may be transmitted or shared, at 809, with different content recommendation services. The personalized delivery schedule 890 may be created, at 815, according to the user’s preferences determined based on, e.g., either declared preferences in some communications or some activities (e.g., content delivered in the morning repeatedly but always observed that the content is not consumed until evening hours). To set up the user-centric content database 680-2, the push content filter 680-1 may filter, at 817, any received recommended/pushed content in accordance with the interest profiles 320 of the user (e.g., summarize to condense the morning news to 15 minutes) and such filtered content may then be archived to establish, at 819, the user-centric content database 680-2, which may be accessible to the push content delivery unit 680-3 to deliver to the user according to the personalized delivery schedule 890.

FIG. 8C is a flowchart of an exemplary process of the execution engine 610 of an AAPA to carry out a task associated with a pull product/service, in accordance with an embodiment of the present teaching. When the task execution controller 810 receives the next tasks to be performed, it may first check, at 822, to determine the delivery schedule of the relevant product/service associated with the tasks. If it is on schedule, the task execution controller 810 may proceed to identify, at 825, the product/service relevant to the task and then determine the nature of the task in order to invoke an appropriate module to carry out the task.

As discussed herein, depending on the nature of a current task, a module specifically provided to perform that type of task. If the current task is to help the user to identify a product/service to meet the user’s expressed needs, the product identifier 820 is invoked to search, at 835, a product/service that can meet the user’s needs. If such a product/service is found, the product sign-up engine 830 is invoked to automatically sign up for the product/service. If no such product is found to meet the user’s needs, the new need archiver 860 is invoked to generate unavailable product/feature description and add to the storage for the new needs 530. If the current task is to customize some function/feature of a product, the product customization engine 850 is invoked to customize, at 855, relevant product function/feature based on the user’s preferences by, e.g., changing parameters to APIs exposed by the product. For example, if a product is an online local content recommendation application, the customization a user may desire may involve the type of content interested (e.g., healthcare system in each locale) and sources of the recommended content (e.g., official publication on the local healthcare department). In this case, if the example application includes a component responsible for searching for local content and if the API for this component is provided in the product knowledge database 300 with specified parameters including a query. Given that, the customization may include automatic generation of one or more queries formulated according to the user’s interests to limit the searched content to be in the domain of healthcare system from the local healthcare department. When such customized queries are generated, they may be provided to the component as parameters so that local content satisfying the user’s preference may be obtained automatically for the user. Such customization may also be used to update the product information in the user-centric product information database 660. If the current task is to assist the user to provide the user’s opinion/review about a product, the product review engine 870 is invoked to interface with the product according to the product knowledge to provide, at 885, the product review/opinion/feedback.

With the current advancement of AI related technologies, generative AI is capable of generating, automatically, software codes based on some given input parameters. This may be utilized by the AAPA to create new software products based on design parameters obtained based on user’s needs/desires/preferences. If the current task involves some user’s specification of a new product/function, the task execution controller 810 may invoke the product/function/feature creator 840 to create, at 845, software codes using parameters obtained based on user’s design. The exemplary task execution modules as presented in this embodiment are provided as illustration instead of as limitations. Other tasks or modules may be incorporated in the execution engine 610 to carry out other types of tasks to automatically assist users to maneuver in the comer environment to use, customize, create, and maintain products/services that can meet the users’ needs/desires. Upon completion of the current task by any of the modules illustrated above, the execution report unit 880 is invoked to generate, at 895, a report on the task execution status, which is sent, at 897, to the NL dialogue engine 720 so that a response may be generated to update the user on the progress made by AAPA.

FIG. 8D is a flowchart of an exemplary process of the execution engine 610 of an AAPA to carrying out tasks related to content product/service, in accordance with an embodiment of the present teaching. When a next task is retrieved, at 801, from a task queue, it is determined, at 802, whether the task is a pull or a push type of content service. If it is a pull type of content service, e.g., the user may have asked in a conversation with AAPA the definition of some technology term, the pull content generator 680-4 may be invoked to analyze, at 803, the user’s desire expressed during the ongoing communication and automatically generate, at 804, a query or a prompt according to the user’s expressed interests. To acquire/pull content from the network that satisfies the user’s desire, one or more sources may be selected at 811 for pulling the content and the query/prompt generated may be used to inquire the selected sources for the content that the user is interested. When the selected sources return the content pulled from the network based on the query/prompt, it is presented, at 813, to the user.

If the next task is related to a push type of service, the push content delivery unit 680-3 may be invoked to deliver pushed content to the user. To do so, the push content delivery unit 680-3 may first check, at 821, the personalized delivery schedule 890 on the scheduled time to deliver the content recommended by some push products/services. At some scheduled delivery time, archived content in user-centric content database 680-2 that is previously pushed/recommended may be checked to identify, at 822, the content to be delivered at the present time. For any piece of recommended content that is scheduled to be delivered, the push content delivery unit 680-3 analyzes, at 823, the individual interest profiles 320 associated with the user to determine the preferred delivery style (e.g., acoustic as opposed to textual). The user’s preferred content delivery style is utilized to generate, at 824, the content for delivery according to the user/s preferred style and the recommended content in its preferred delivery style is then delivered, at 831, to the user at the scheduled time. Whether it is a pull or a push related operation, a status report is generated and sent, at 814, to the execution report unit 880.

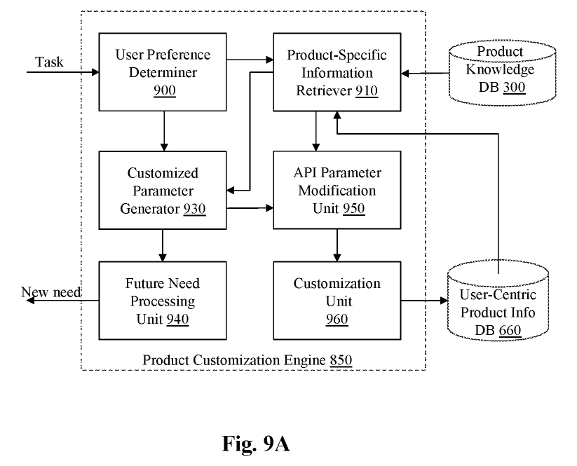

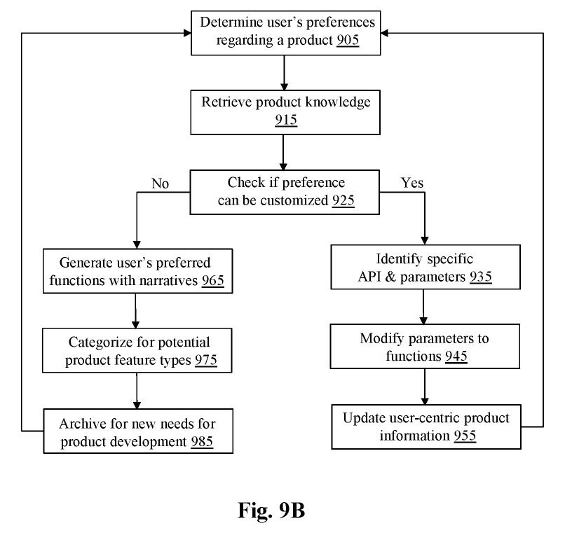

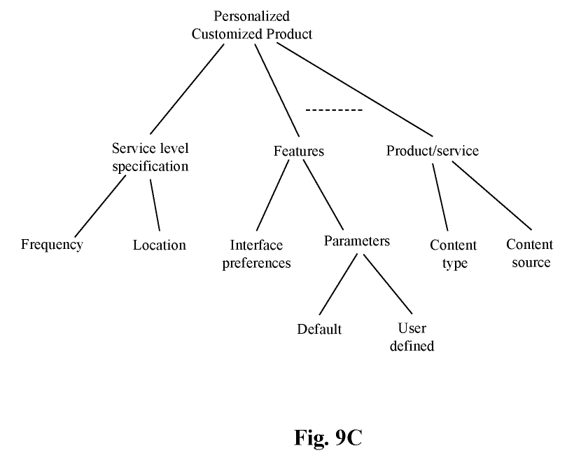

Details of one exemplary module in FIG. 8A are provided herein to illustrate what AAPA may achieve. FIG. 9A depicts an exemplary high level system diagram of the product customization engine 850, in accordance with an embodiment of the present teaching. As discussed herein, product customization engine 850 is provided for carrying out a task related to automatically customizing, on behalf of a user, a function or a feature associated with a product based on detected preferences of the user. This illustrated module is provided for customizing a software product. As discussed herein, different functions/features of a software product may be customized if the product knowledge about certain components thereof is exposed that allows the AAPA to accordingly provide preferred parameters to the customizable components. In this illustrated embodiment, the product customization engine 850 comprises a user preference determiner 900, a product-specific information retriever 910, a customized parameter generator 930, an API parameter modification unit 950, a customization unit 960, and a future need processing unit 940.

FIG. 9B is a flowchart of the product customization engine, in accordance with an embodiment of the present teaching. In operation, when receiving a current task to be carried out, the user preference determiner 900 determines, at 905, the user’s preferences based on the description of the task. For example, the current task may be directed to customization of a product by enlarging the font size to 14 directed to a component of the product for displaying digital content on screen. In this case, the preference is 14 font size. Based on that, the product-specific information retriever 910 is activated to retrieve, at 915, product knowledge related to the product from database 300. Such product knowledge is either from the product knowledge database 300 or from the user-centric product information database 660. The retrieved product knowledge is used to determiner, at 925, whether the user’s preferred customization can be achieved. For instance, if the API of the component for displaying content is exposed and the specified parameters to call this API include font size, then the font size is customizable. Otherwise, it is not.

If the relevant product is customizable with respect to the user’s preference, the customized parameter generator 930 identifies, at 935, the specific API and the specific parameter that is to be modified to achieve customization so that the API parameter modification unit 950 executes the modification, at 945, to implement the customization. Such a change to the original API parameters may then be used by the customization unit 960 to update the information in the user-centric product information database 660. Such changed API parameters ensure that future calls to the relevant product component will use the modified parameters to make the product to deliver customized features. If the product currently does not allow customization of the function/feature as preferred by the user, then the user preferred function/feature may be archived as new needs. In this case, the future need processing unit 940 is invoked to generate, at 965, a description of the user’s preferred function/feature and categorize, at 975, its type and other summarization information before it archives, at 985, the new needs in the storage.

FIG. 9C illustrates an exemplary product with multiple features some of which are personally customized by an AAPA on behalf of a user based on the know preferences of the user, in accordance with an embodiment of the present teaching. The illustrated personally customized product may operate to function according to parameters in different categories, including parameters at service level (e.g., the timing, frequency, and location of the service delivery), product features, …, or specific product/service to be delivered. Using the example of a product for recommending local content to users based on their device locations, the product/service provided involves content curated from a locale where the users’ devices are. The product features may include the graphical user interface related features implemented using various parameters specified. In this example, the customization may include, e.g., limiting the source or type of content to be recommended, as illustrated in FIG. 9C. For instance, if a user has a business trip to visit different cities to collect information about local healthcare operations in these cities, the user may desire to have the local content recommendation app to automatically recommend local content in this space from official sources (e.g., local healthcare department). In this case, the user may communicate with the AAPA to express the preference that during this trip, the only type of content is related to local healthcare management described by local healthcare authorities. Understanding the user’s preferences, the AAPA may customize the product by limiting the curation of local content to healthcare related content from local healthcare authorities in whatever locale the user is in.

Using the same example, when the user travels to different cities to collect information, the user may prefer that the curated local content regarding healthcare management be conveyed to the user in certain ways, e.g., sending a copy of each locale’s healthcare report to the user’s work email in addition to presenting the recommended content on the device screen. The user may communicate such preferences to the AAPA, which may then proceed to customize relevant features of the example product to implement what the user’s preferences by, e.g., modifying the default settings of the product to replace with user defined setting so that any recommended content may be sent to a designated email address and displayed on screen. When the user is in transit (e.g., on a bus or a train), it may be difficult to read the recommended content on the device (e.g., due to motion sickness), the user may talk to the AAPA about it. Understanding the problem, the AAPA may suggest switching the content delivery means to reading the content. With the user’s consent, the AAPA may again customize the product by changing the delivery on device to read the content using text-to-speech. In this manner, an AAPA according to the present teaching may communicate with a user on any dynamically arising needs/desires on a product and then adapt the product according to the user’s desires with respect to features that the product permits customization.

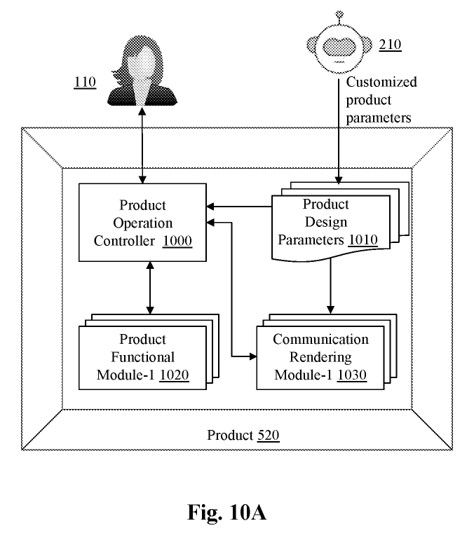

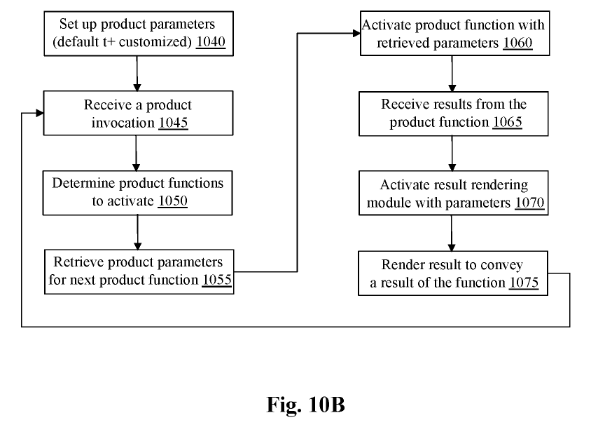

As discussed herein, the APAA according to the present teaching is provided to assist a user to identify, sign up, and customize products so long as the products participating a commerce environment in which the APAA operates. A developer of a product or a host of a service may participate in the commerce environment by specifying information needed for the APAA to interface with the product or service to design/specify/modify/implement some functions/features that are exposed as subject to changes. FIG. 10A depicts an exemplary high-level construct of a product (e.g., a software product) that an AAPA may interface to customize certain functions/features based on a user’s preferences, in accordance with an embodiment of the present teaching. In this illustrated embodiment, product 520 takes, from APAA, input customized product parameters created based on some user’s preferences and stores as its product design parameters so that when the AAPA provided parameters are used by the product in operation, the product delivers customized services to the user. In this illustrated embodiment, the product 520 is structured to include a product operation controller 1000 provided to control the invocation and execution, during the operation of the production, associated with appropriate product functional modules in 1020 for carrying out functions intended and/or relevant communication rendering modules 1030 using parameters from an archive 1010 storing product design parameters. As discussed herein, when the product design parameters stored in 1010 is changed by AAPA, the product 520 is customized.

FIG. 10B is a flowchart of product 520 in FIG. 10A to produce customized functionalities based on customized product design parameters set up by an AAPA based on a user’s preferences, in accordance with an embodiment of the present teaching. Product 520 may be initially configured by specifying a list of product design parameters, some of which may be defined using default values and for some the parameter values may be left undefined so that they may be defined or designed by an AAPA on behalf of each individual according to the personal preferences. The initially defined default parameter values may also be modified to represent renewed preferences. At step 1040, the product 520 is set up based on both default and user defined parameters received from an AAPA. When the configured product is invoked at 1045, the product operation controller 1000 determines, at 1050, one or more product functions according to information received with the invocation. For instance, if the product 520 is a local content recommendation app, when it is activated with a query from a user, the product operation controller 1000 may determine to invoke several product functional modules from 1020, including one module for determining the locale that the user is currently at, one module for modifying the user’s query to generate a modified query directed to the locale, and one module for searching the local content based on the modified query. In addition, to present the searched content to the user, a communication rendering module in 1030 may be identified to present the searched content to the user. In some situations, the determination of the module to activate may also depend on the product design parameters in 1010. For example, if a default design is to present the searched content on device, then a communication rendering module for that may be activated. But if it is subsequently customized to deliver the content in audio, a different communication rendering module in 1030 may be activated.

With the determination of appropriate modules to activate, the product operation controller 1000 may then proceed to control to carry out a sequence of functions to render the service. To execute a functional module, the product operation controller 1000 retrieves, at 1055, product parameters associated therewith from storage 1010 and provided to the functional module as input and then activates, at 1060, the functional module. Upon receiving, at 1065, the results from the executed functional module, the product operation controller 1000 activates, at 1070, a communication rendering module from 1030 with product parameters associated therewith so that the results may be rendered, at 1075, to the user according to the product parameters (default or customized). In this manner, through the product parameters that may include either default parameters set by the product developer or customized product parameters set by the AAPA according to a user’s preferences, the product 520 may deliver customized services to the user based on the present teaching.

In addition to online app like products as illustrated herein, the AAPA according to the present teaching may also handle other conventional types of product customization based on users’ preferences such as making reservations at restaurants, hotels, rentals, events, etc. Through conversations with a user about having a family gathering at some local restaurant offering a preferred type of food (e.g., Italian), an AAPA may search available products 220 in the commerce environment, discuss with the user which one is desired, possible dates, and the number of people to attend, and receive confirmation from the user. To fulfill the user’s desires, the AAPA may identify, from the product knowledge on the restaurant, the contact information for making reservations, whether it is a website or a phone number. Using the contact information, the AAPA may proceed to act on behalf of the user to reserve for the user’s desired family gathering. For instance, based on the stated preferences from the user, the AAPA may generate the necessary parameters for the reservation, including date, time, and the number of people and then automatically make the reservation accordingly on a website by filling in relevant information. If the contact information represents a phone number, the AAPA may also auto dial the phone number and communicate with the restaurant in a natural language communication to complete the reservation. It is evident that the AAPA according to the present teaching may free users from the burden and frustration of dealing with a vast range of products/services, assist users to effectively receive different services according to their preferences, and to adapt products on-the-fly to take care of users’ dynamic needs. On software products, AAPA may leverage generative capability of current state of the art in AI to create new products with functions and features individually designed by each individual users and implemented to deliver personally customized products.

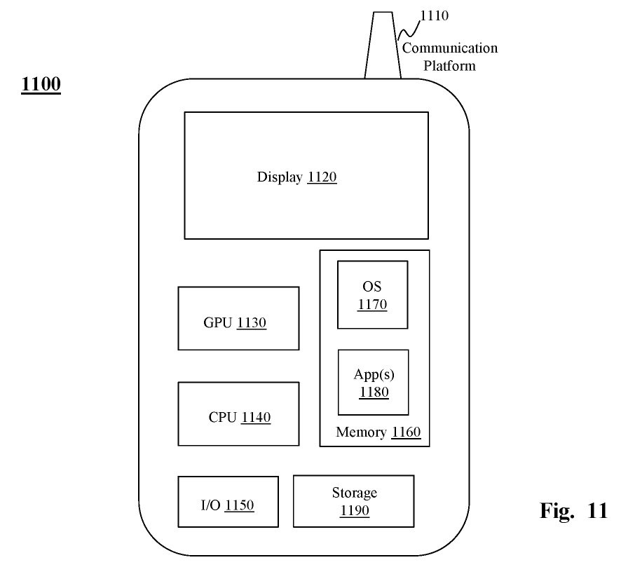

FIG. 11 is an illustrative diagram of an exemplary mobile device architecture that may be used to realize a specialized system implementing the present teaching in accordance with various embodiments. In this example, the user device on which the present teaching may be implemented corresponds to a mobile device 800, including, but not limited to, a smart phone, a tablet, a music player, a handled gaming console, a global positioning system (GPS) receiver, and a wearable computing device, or a mobile computational unit in any other form factor. Mobile device 1100 may include one or more central processing units (“CPUs”) 1140, one or more graphic processing units (“GPUs”) 1130, a display 1120, a memory 1160, a communication platform 1110, such as a wireless communication module, storage 1190, and one or more input/output (I/O) devices 1150. Any other suitable component, including but not limited to a system bus or a controller (not shown), may also be included in the mobile device 1100. As shown in FIG. 11, a mobile operating system 1170 (e.g., iOS, Android, Windows Phone, etc.) and one or more applications 1180 may be loaded into memory 1160 from storage 1190 in order to be executed by the CPU 1140. The applications 1180 may include a user interface or any other suitable mobile apps for information exchange, analytics, and management according to the present teaching on, at least partially, the mobile device 1100. User interactions, if any, may be achieved via the I/O devices 1150 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

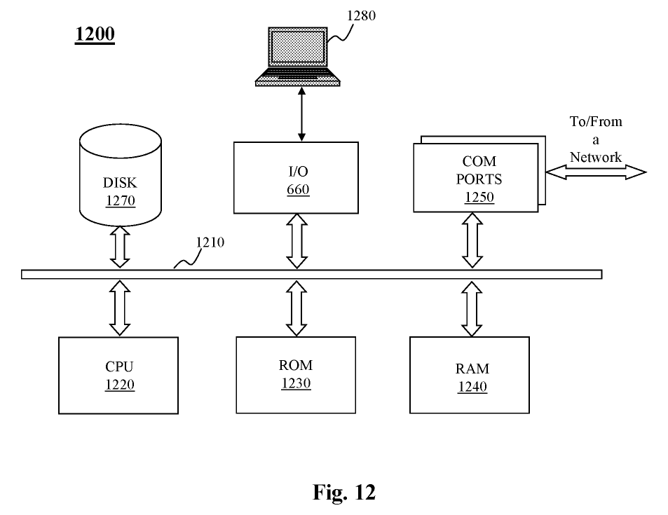

FIG. 12 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special-purpose computer. Both can be used to implement a specialized system for the present teaching. This computer 1200 may be used to implement any component or aspect of the framework as disclosed herein. For example, the information analytical and management method and system as disclosed herein may be implemented on a computer such as computer 1200, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 1200, for example, includes COM ports 1250 connected to and from a network connected thereto to facilitate data communications. Computer 1200 also includes a central processing unit (CPU) 1220, in the form of one or more processors, for executing program instructions. The exemplary computer platform includes an internal communication bus 1210, program storage and data storage of different forms (e.g., disk 1270, read only memory (ROM) 1230, or random-access memory (RAM) 1240), for various data files to be processed and/or communicated by computer 1200, as well as possibly program instructions to be executed by CPU 1220. Computer 1200 also includes an I/O component 1260, supporting input/output flows between the computer and other components therein such as user interface elements 1280. Computer 1200 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable the loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or a physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as the main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, a hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method for an artificial intelligence assisted product agent (AAPA), comprising:
conducting communication with a user in a natural language regarding a product providing a service to the user on a device of the user;
updating interests/preferences of the user based on the communication, including a preference of the user regarding a service feature of the product;
retrieving product knowledge associated with the product specified to facilitate automated interaction between the AAPA and the product;
interfacing with the product based on the product knowledge to yield a customized product for the user with the service feature automatically implemented in accordance with the preference of the user regarding the service feature;
delivering, to the user via the customized product, the service on the device via the service feature in a manner preferred by the user.

2. The method of claim 1, wherein
the communication between the AAPA and the user is via a text or oral dialogue;
the natural language is one that the user is accustomed to.

3. The method of claim 1, wherein
the product includes an online product;
the service provided by the product includes content related service;
the service feature includes displaying content to the user on the device; and
the preference regarding the service feature includes desired manner to display content on the device.

4. The method of claim 3, wherein the desired manner to display content on the device includes one or more of:
brightness of the display;
layout on the device for different pieces of the content being displayed;
color of text in the content;
font style of the text; and
font size applied to text in the content.

5. The method of claim 1, wherein the product knowledge associated with the product includes one or more of:
general information about the product;
service information associated with one or more services provided by the product;
function information describing functions associated with each of the one or more services;
a summary regarding customizable functions in the one or more services.

6. The method of claim 5, wherein the general information about the product includes one or more of:
an indication of a category of the product;
a name of the product with an identifier to be used to identify the product; and
a description of the product including a sub-description for each of the one or more services the product provides.

7. The method of claim 5, wherein the service information includes at least one of:
a description regarding each of the one or more services;
election requirement needed to elect each of the one or more services; and
service terms associated with each of the one or more services.

8. The method of claim 5, wherein the function information describing functions associated with each of the one or more services includes at least one of:
a specification directed to each of the functions, including:
a role of the function relating to the service,
an instruction about how to activate the function,
one or more parameters that the function utilize to operate,
an indication as to whether any of the one or more parameters is customizable, and
default values of the one or more parameters.

9. The method of claim 8, wherein the interfacing with the product to yield a customized product comprises:
determining a function associated with the service feature in connection with the user’s preference;
analyzing the product knowledge to identify customizable parameters associated with the function;
determining values of the customizable parameters based on the preference of the user;
creating the customized product for the user with the function configured with the values for the customizable parameters.

10. The method of claim 2, wherein the preference of the user as well as the interests/preferences of the user are
recognized from expression of the user during the communication; and/or
inferred from the communication.

11. The method of claim 3, wherein the preference of the user is directed to content, either pulled from one or more sources via an inquiry or pushed to the user from at least one recommendation source via recommendations.

12. The method of claim 11, wherein the inquiry is automatically generated by the AAPA based on a need detected from the communication.

13. The method of claim 11, wherein the at least one recommendation source push content to the user in accordance with the interests/preferences of the user provided thereto by the AAPA.

14. A machine-readable and non-transitory medium having information recorded thereon for an artificial intelligence assisted product agent (AAPA), wherein the information, when read by the machine, causes the machine to perform the following steps:
conducting communication with a user in a natural language regarding a product providing a service to the user on a device of the user;
updating interests/preferences of the user based on the communication, including a preference of the user regarding a service feature of the product;
retrieving product knowledge associated with the product specified to facilitate automated interaction between the AAPA and the product;
interfacing with the product based on the product knowledge to yield a customized product for the user with the service feature automatically implemented in accordance with the preference of the user regarding the service feature;
delivering, to the user via the customized product, the service on the device via the service feature in a manner preferred by the user.

15. The medium of claim 14, wherein
the communication between the AAPA and the user is via a text or oral dialogue;
the natural language is one that the user is accustomed to.

16. The medium of claim 14, wherein
the product includes an online product;
the service provided by the product includes content related service;
the service feature includes displaying content to the user on the device; and
the preference regarding the service feature includes desired manner to display content on the device.

17. The medium of claim 16, wherein the desired manner to display content on the device includes one or more of:
brightness of the display;
layout on the device for different pieces of the content being displayed;
color of text in the content;
font style of the text; and
font size applied to text in the content.

18. The medium of claim 14, wherein the product knowledge associated with the product includes one or more of:
general information about the product;
service information associated with one or more services provided by the product;
function information describing functions associated with each of the one or more services;
a summary regarding customizable functions in the one or more services.

19. The medium of claim 18, wherein the general information about the product includes one or more of:
an indication of a category of the product;
a name of the product with an identifier to be used to identify the product; and
a description of the product including a sub-description for each of the one or more services the product provides.

20. The medium of claim 18, wherein the service information includes at least one of:
a description regarding each of the one or more services;
election requirement needed to elect each of the one or more services; and
service terms associated with each of the one or more services.

21. The medium of claim 18, wherein the function information describing functions associated with each of the one or more services includes at least one of:
a specification directed to each of the functions, including:
a role of the function relating to the service,
an instruction about how to activate the function,
one or more parameters that the function utilize to operate,
an indication as to whether any of the one or more parameters is customizable, and
default values of the one or more parameters.

22. The medium of claim 21, wherein the interfacing with the product to yield a customized product comprises:
determining a function associated with the service feature in connection with the user’s preference;
analyzing the product knowledge to identify customizable parameters associated with the function;
determining values of the customizable parameters based on the preference of the user;
creating the customized product for the user with the function configured with the values for the customizable parameters.

23. The medium of claim 15, wherein the preference of the user as well as the interests/preferences of the user are
recognized from expression of the user during the communication; and/or
inferred from the communication.

24. The medium of claim 16, wherein the preference of the user is directed to content, either pulled from one or more sources via an inquiry or pushed to the user from at least one recommendation source via recommendations.

25. The medium of claim 24, wherein the inquiry is automatically generated by the AAPA based on a need detected from the communication.

26. The medium of claim 24, wherein the at least one recommendation source push content to the user in accordance with the interests/preferences of the user provided thereto by the AAPA.
